(19) United States
(12) Patent Application Publication
(10) Pub. No.: US 2025/0371846 A1
(43) Pub. Date: Dec. 4, 2025

(54) METHOD, APPARATUS, ELECTRONIC DEVICE, AND COMPUTER-READABLE MEDIUM FOR CONSTRUCTING MODEL

(71) Applicant: Beijing Zitiao Network Technology Co., Ltd., Beijing (CN)

(72) Inventors: Jie WU, Beijing (CN); Ming LI, Beijing (CN); Xionghui WANG, Beijing (CN); Xuefeng XIAO, Beijing (CN)

(21) Appl. No.: 18/877,989

(22) PCT Filed: Nov. 20, 2023
(86) PCT No.: PCT/CN2023/132631

§ 371 Date: Dec. 20, 2024

(30) Foreign Application Priority Data
Dec. 19, 2022 (CN) 202211634668.2

(51) Int. Cl. G06V 10/764

(52) U.S. Cl. CPC G06V 10/765

(57) ABSTRACT

The present disclosure discloses a method, an apparatus, an electronic device and a computer-readable medium for constructing a model. The method includes: training a model to be processed using a first dataset to obtain a first model, constructing a second model according to the backbone network in the first model and training the second model using a second dataset, and constantly keeping network parameters of the backbone network in the second model unchanged during training of the second model so as to obtain a model to be used.

This application claims priority to Chinese Patent Application No. 202211634668.2, filed with the China National Intellectual Property Administration on Dec. 19, 2022, and entitled “METHOD AND APPARATUS, ELECTRONIC DEVICE AND COMPUTER-READABLE MEDIUM FOR CONSTRUCTING MODEL”, which is incorporated herein by reference in its entirety.

### FIELD

The present disclosure relates to the technical field of image processing, and in particular, to a method, an apparatus, an electronic device and a computer-readable medium for constructing a model.

### BACKGROUND

For some image processing fields (e.g., the fields of target detection, semantic segmentation, or key point detection), a machine learning model can be used in these image processing fields to implement image processing tasks (e.g., target detection task, semantic segmentation task, or key point detection task) involved in the image processing fields.

However, how to construct the above machine learning model is a pressing technical problem to be solved.

### SUMMARY

The present disclosure provides a method, an apparatus, an electronic device and a computer-readable medium for constructing a model, which can achieve the objective of constructing a machine learning model in a certain image processing field.

In order to achieve the above objective, the present disclosure provides the following technical solutions.

The present disclosure provides a method for constructing a model, including:
training a model to be processed using a first dataset to obtain a first model, where the first dataset includes at least one first image data, and the first model includes a backbone network;
constructing a second model according to the backbone network in the first model, where the second model includes the backbone network and a first processing network, and the first processing network refers to all or part of other networks other than the backbone network in the second model; and
training the second model using a second dataset to obtain a model to be used, where the model to be used includes the backbone network and a second processing network, network parameters of the backbone network in the second model are kept unchanged during the training of the second model, the second processing network refers to a training result of the first processing network in the second model, and the second dataset includes at least one second image data.

In a possible implementation, the first processing network is used to process output data of the backbone network to obtain an output result of the second model.

In a possible implementation, the first image data belongs to single-object image data;
and/or,
the second image data includes at least two objects.

In a possible implementation, the method further includes:
initializing an online model and a momentum model using the second model;
training the second model using the second dataset to obtain the model to be used includes:
determining the model to be used according to the second dataset, the online model, and the momentum model.

In a possible implementation, determining the model to be used includes:
selecting image data to be processed from the at least one second image data;
obtaining at least two image data to be used and object area labels corresponding to the at least two image data to be used, where the image data to be used is determined according to the image data to be processed, and the object area labels corresponding to the image data to be used are determined according to object area labels corresponding to the image data to be processed;
determining object area prediction results corresponding to the at least two image data to be used using the online model and the momentum model; and
updating the online model and the momentum model according to the object area prediction results corresponding to the at least two image data to be used and the object area labels corresponding to the at least two image data to be used, continuing performing selecting the image data to be processed from the at least one second image data, and when a preset stopping condition is met, determining the model to be used according to the online model.

In a possible implementation, the at least two image data to be used includes at least one third image data and at least one fourth image data;
an object area prediction result corresponding to the third image data is determined using the online model; and
an object area prediction result corresponding to the fourth image data is determined using the momentum model.

In a possible implementation, updating the online model and the momentum model according to the object area prediction results corresponding to the at least two image data to be used and the object area labels corresponding to the at least two image data to be used includes:
determining a regression loss corresponding to the online model according to an object area prediction result corresponding to the at least one third image data and object area labels corresponding to the at least one third image data;
determining a contrastive loss corresponding to the online model according to the object area prediction result corresponding to the at least one third image data and an object area prediction result corresponding to the at least one fourth image data;
updating the online model according to the regression loss and the contrastive loss; and
updating the momentum model according to the updated online model.

In a possible implementation, updating the online model and the momentum model according to the object area prediction results corresponding to the at least two image data to be used and the object area labels corresponding to the at least two image data to be used includes:
determining a model loss of the online model according to the object area prediction results corresponding to the at least two image data to be used and the object area labels corresponding to the at least two image data to be used;
updating network parameters of a first processing network in the online model according to the model loss; and
updating network parameters of a first processing network in the momentum model according to the network parameters of the first processing network in the updated online model.

In a possible implementation, updating network parameters of the first processing network in the momentum model according to the network parameters of the first processing network in the updated online model includes:
performing weighted summation processing on the network parameters of the first processing network in the momentum model before updating and the network parameters of the first processing network in the updated online model, to obtain network parameters of the first processing network in the updated momentum model.

In a possible implementation, the object area label includes at least one target area representation data, and the object area prediction result includes at least one predicted area feature;
the method further includes:
determining a positive sample and a negative sample of respective predicted area features corresponding to the at least one third image data from at least one predicted area feature corresponding to the at least one fourth image data based on a correspondence between at least one target area representation data corresponding to the third image data and at least one target area representation data corresponding to the fourth image data;
where determining the contrastive loss corresponding to the online model according to the object area prediction result corresponding to the at least one third image data and the object area prediction result corresponding to the at least one fourth image data includes:
determining the contrastive loss corresponding to the online model according to at least one predicted area feature corresponding to the at least one third image data, and the positive sample and the negative sample of respective predicted area features corresponding to the at least one third image data.

In a possible implementation, the object area prediction result further includes predicted area representation data corresponding to respective predicted area features;
the at least one predicted area feature corresponding to the third image data includes an area feature to be used;
target area representation data corresponding to a positive sample of the area feature to be used has a correspondence with target area representation data corresponding to the area feature to be used;
target area representation data corresponding to a negative sample of the area feature to be used has no correspondence with the target area representation data corresponding to the area feature to be used;
the target area representation data corresponding to the positive sample is determined according to the size of the overlapping area between predicted area representation data corresponding to the positive sample and each target area representation data corresponding to the fourth image data to which the positive sample belongs;
the target area representation data corresponding to the area feature to be used is determined according to the size of the overlapping area between predicted area representation data corresponding to the area feature to be used and each target area representation data corresponding to the third image data to which the area feature to be used belongs; and
the target area representation data corresponding to the negative sample is determined according to the size of the overlapping area between predicted area representation data corresponding to the negative sample and each target area representation data corresponding to the fourth image data to which the negative sample belongs.

In a possible implementation, obtaining the object area labels corresponding to the image data to be processed includes:
performing object area searching on the image data to be processed using a selective search algorithm to obtain the object area labels corresponding to the image data to be processed;
or,
obtaining the object area labels corresponding to the image data to be processed includes:
looking up the object area labels corresponding to the image data to be processed from a pre-constructed mapping relationship, where the mapping relationship includes a correspondence between respective second image data and the object area labels corresponding to respective second image data; and the object area labels corresponding to the second image data are determined by performing the object area searching on the second image data using the selective search algorithm.

In a possible implementation, the output result of the second model is a target detection result, a semantic segmentation result, or a key point detection result.

In a possible implementation, training the model to be processed using the first dataset to obtain the first model includes:
performing fully-supervised training on the model to be processed using the first dataset to obtain the first model;
or,
performing self-supervised training on the model to be processed using the first dataset to obtain the first model.

In a possible implementation, the method further includes:
fine-tuning the model to be used using a preset image dataset to obtain an image processing model, where the image processing model includes a target detection model, a semantic segmentation model, or a key point detection model.

The present disclosure provides an apparatus for constructing a model, including:
a first training unit, configured to train a model to be processed using a first dataset to obtain a first model, where the first dataset includes at least one first image data, and the first model includes a backbone network;
a model construction unit, configured to construct a second model according to the backbone network in the first model, where the second model includes the backbone network and a first processing network, and the first processing network refers to all or part of other networks other than the backbone network in the second model; and
a second training unit, configured to train the second model using a second dataset to obtain a model to be used, where the model to be used includes the backbone network and a second processing network, network parameters of the backbone network in the second model are kept unchanged during the training of the second model, the second processing network refers to a training result of the first processing network in the second model, and the second dataset includes at least one second image data.

The present disclosure provides an electronic device. The device includes a processor and a memory;
the memory is configured to store an instruction or a computer program; and
the processor is configured to execute the instruction or the computer program in the memory to cause the electronic device to perform a method for constructing a model provided in the present disclosure.

The present disclosure provides a computer-readable medium, having an instruction or a computer program stored therein. The instruction or the computer program, when run on a device, causes the device to perform the method for constructing the model provided in the present disclosure.

The present disclosure provides a computer program product, including a computer program carried on a non-transitory computer-readable medium. The computer program includes program code used to perform a method for constructing a model provided in the present disclosure.

### BRIEF DESCRIPTION OF THE DRAWINGS

In order to describe technical solutions in embodiments of the present disclosure or in the prior art more clearly, the accompanying drawings required to be used in descriptions of the embodiments or the prior art will be briefly introduced below, it is apparent that the accompanying drawings described below are merely some embodiments recited in the present disclosure, and those of ordinary skill in the art can obtain other accompanying drawings according to these accompanying drawings without creative work.

FIG. 1 is a flowchart of a method for constructing a model provided in the present disclosure;

FIG. 2 is a schematic diagram of the pre-training of a backbone network provided in the present disclosure;

FIG. 3 is a schematic diagram of the pre-training of other networks other than a backbone network in a model provided in the present disclosure;

FIG. 4 is a flowchart of another method for constructing a model provided in the present disclosure;

FIG. 5 is a schematic diagram of the structure of an apparatus for constructing a model according to an embodiment of the present disclosure;

FIG. 6 is a schematic diagram of the structure of another apparatus for constructing a model according to an embodiment of the present disclosure; and

FIG. 7 is a schematic diagram of the structure of an electronic device according to an embodiment of the present disclosure.

### DETAILED DESCRIPTION OF EMBODIMENTS

Through researches, it has been found that for some image processing fields (e.g., fields such as target detection), an image processing model used in the image processing field (e.g., target detection model) may typically be constructed using a pre-training plus fine-tuning method.

Through the researches, it has also been found that for some implementations for the above pre-training plus fine-tuning method, there are inconsistencies between pre-training and fine-tuning involved in these implementations, which are shown in \textcircled{1} to \textcircled{3} below. These inconsistencies in turn adversely affect the image processing effect of the image processing model constructed using these implementations, and as a result, the image processing effect of the image processing model constructed using these implementations is less ideal.

\textcircled{1} Inconsistency in training objects, which is caused specifically as follows: in the above implementations, only the backbone network in the image processing model (e.g., the target detection model) is trained during pre-training, while all networks in the image processing model need to be trained during fine-tuning, and as a result, objects that need to be trained during pre-training are different from those that need to be trained during fine-tuning, which leads to differences in training objects during pre-training and the fine-tuning.
\textcircled{2} Inconsistency in image data, which is caused specifically as follows: in the above implementations, only single-object image data is used to be pre-trained during pre-training, while multi-object image data needs to be used for fine-tuning during fine-tuning, and as a result, the type of the image data used during pre-training is different from the type of the image data used during fine-tuning, which leads to differences in the image data during pre-training process and fine-tuning.
\textcircled{3} Inconsistency in learning tasks, which is caused specifically as follows: in the above implementations, pre-training typically only focuses on a classification task, while fine-tuning needs to focus on the classification task and a regression task at the same time, and as a result, the learning tasks focused on during pre-training are fewer than those focused on during fine-tuning, which leads to differences in the learning tasks during pre-training process and fine-tuning.

On the basis of the above findings, the present disclosure provides a method for constructing a model that may be applied to some image processing fields (e.g., fields such as target detection, semantic segmentation, or key point detection). The method includes: for a machine learning model (e.g., target detection model, semantic segmentation model, or key point detection model) used in the image processing fields, using a first dataset (e.g., a large amount of single-object image data) to train a model to be processed to obtain a first model, such that a backbone network in the first model has a good image feature extraction function, thereby achieving the pre-training of the backbone network in the machine learning model; then, constructing a second model according to the backbone network in the first model, such that an image processing function achieved by the second model is kept consistent with an image processing function to be achieved by the machine learning model; and then, using a second dataset (e.g., some multi-object image data) to train the second model, and constantly keeping network parameters of the backbone network in the second model unchanged in a training process of the second model, such that when the trained second model is determined as the model to be used, the backbone network in the model to be used is kept consistent with the backbone network in the first model, and a second processing network in the model to be used refers to a training result of a first processing network in the second model, thus other networks in the machine learning model may be pre-trained on the premise of fixing the backbone network, a well-constructed image processing model (e.g., the target detection model) with good image processing performance can be obtained by subsequently fining tuning the model to be used, and construction processing of the machine learning model in these image processing fields may be achieved accordingly.

Additionally, for the method for constructing the model provided in the present disclosure, not only the backbone network in the above image processing model (e.g., the target detection model) can be pre-trained, but also other networks other than the backbone network in the image processing model (e.g., detection head network) can be pre-trained. As such, all networks in the finally pre-trained model have good data processing performance, thereby effectively avoiding adverse effects caused by pre-training only the backbone network, so as to effectively improve the image processing effect (e.g., target detection effect) of the finally constructed image processing model.

Additionally, for the method for constructing the model provided in the present disclosure, not only the single-object image data is used for model pre-training, but also the multi-object image data is used for the model pre-training, such that the finally pre-trained model has a good image processing function for the multi-object image data, thereby effectively avoiding adverse effects caused by using only the single-object image data for model pre-training, so as to effectively improve the image processing effect (e.g., the target detection effect) of the final constructed image processing model.

Further, for the method for constructing the model provided in the present disclosure, the method not only focuses on the classification task but also focuses on the regression task, such that the finally pre-trained model has good image processing performance, thereby effectively avoiding adverse effects caused by focusing on only the classification task for pre-training, so as to effectively improve the image processing effect (e.g., the target detection effect) of the final constructed image processing model.

Moreover, the present disclosure does not limit the executing entity of the above model construction method. For example, the method for constructing the model provided in this embodiment of the present disclosure may be applied to a terminal device, a server, or other devices with data processing functions. For another example, the method for constructing the model provided in this embodiment of the present disclosure may also be implemented through a data communication process between the terminal device and the server. The terminal device may be a smart phone, a computer, a personal digital assistant (PDA), a tablet computer, or the like. The server may be a standalone server, a cluster server, or a cloud server.

To facilitate a better understanding of the solutions of the present disclosure by those skilled in the art, the technical solutions in the embodiments of the present disclosure are clearly and completely described with reference to the accompanying drawings in the embodiments of the present disclosure as below, and it is apparent that the described embodiments are merely a part rather all embodiments of the present disclosure. All other embodiments obtained by those of ordinary skill in art based on the embodiments of the present disclosure without creative work shall fall within the scope of protection of the present disclosure.

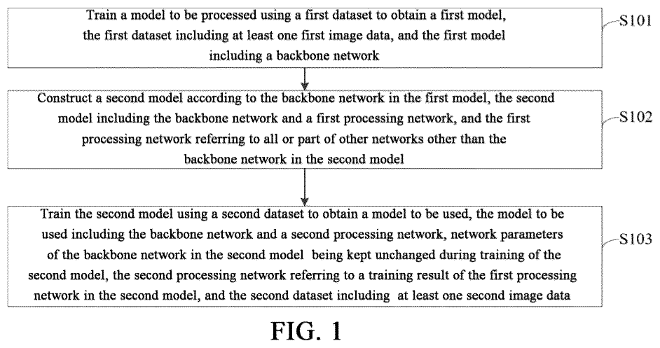

To facilitate a better understanding of the technical solutions provided in the present disclosure, the method for constructing the model provided in the present disclosure is described with reference to some accompanying drawings. As shown in FIG. 1, the method for constructing the model provided in this embodiment of the present disclosure includes the following S101 to S103. FIG. 1 is a flowchart of a method for constructing a model provided in the present disclosure.

S101: Train a model to be processed using a first dataset to obtain a first model, where the first dataset includes at least one first image data, and the first model includes a backbone network.

The first dataset refers to an image dataset required for pre-training the backbone network (Backbone) in an image processing model in a target application field. The target application field refers to an application field of the method for constructing the model provided in the present disclosure, and the preset disclosure does not limit the target application field, which may be, for example, a target detection field, an image segmentation field, or a key point detection field.

Additionally, the present disclosure does not limit the implementation of the above first dataset, which may be, for example, an implementation of any existing or future image dataset (e.g., the image dataset of ImageNet) used for pre-training the backbone network.

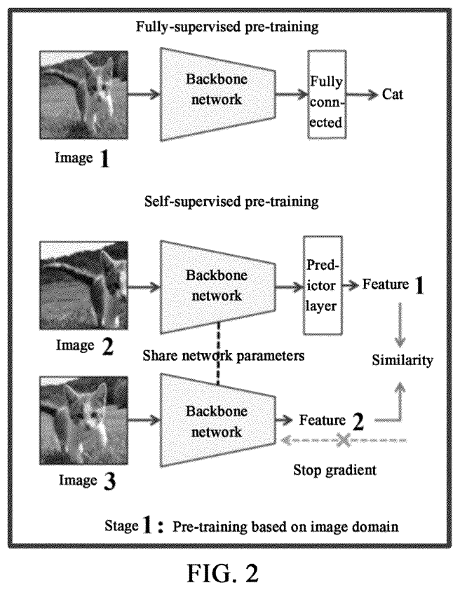

Actually, for the above first dataset, the first dataset may include the at least one first image data. The first image data refers to image data used when pre-training is performed on the backbone network. In addition, the present disclosure does not limit the first image data. For example, in some application scenarios, the first image data may belong to single-object image data (e.g., image 1 shown in FIG. 2, which is single-object image data), such that there is only one object in the first image data (e.g., only one object, which is a cat, in image 1).

The model to be processed refers to a model used when pre-training the backbone network, and the model to be processed may at least include the backbone network.

Additionally, the present disclosure does not limit the implementation of the above model to be processed, and for ease of understanding, a description is made with reference to following two cases.

Case 1: In some application scenarios, fully-supervised pre-training may be performed on the backbone network.

On the basis of above case 1, it can be known that if fully-supervised pre-training is performed on the backbone network, the above model to be processed may be a classification model, and the specific process of training the model to be processed may include: performing fully-supervised training on the model to be processed (e.g., the training shown in the part of “fully-supervised pre-training” in FIG. 2) by using the above at least one first image data and a classification label corresponding to the at least one first image data, and determining the trained model to be processed as the first model. The “classification label corresponding to the first image data” is used to represent the actual category of the first image data; and in addition, the present disclosure does not limit the process of obtaining the “classification label corresponding to the first image data”, which may be, for example, implemented by manual labeling.

It should be noted that the present disclosure does not limit the implementation of the “classification model” in the previous paragraph. For example, when the above target application field is the target detection field, as shown in FIG. 2, the classification model may include a backbone network and a fully connected (FC) layer, where input data of the FC layer includes output data of the backbone network. Additionally, the present disclosure also does not limit the implementation of the step of “performing fully-supervised training on the model to be processed” in the previous paragraph.

On the basis of the above case 1 and related content of “fully-supervised pre-training” shown in FIG. 2, it can be known that in some application scenarios, fully-supervised pre-training may be performed on the backbone network using large-scale image data and corresponding classification labels, such that the pre-trained backbone network has good image feature extraction performance. It can be seen that in a possible implementation, the above model to be processed may be a classification model.

Case 2: In some application scenarios, self-supervised pre-training may be performed on the backbone network.

On the basis of the above case 2, it can be known that if self-supervised pre-training is performed on the backbone network, the above model to be processed may include a backbone network and a predicator layer, and input data of the predicator layer includes output data of the backbone network. Additionally, the specific process of training the model to be processed may include: using the above at least one first image data to perform self-supervised training on the model to be processed (e.g., the training process shown in the part of “self-supervised pre-training” in FIG. 2), and determining the trained model to be processed as the first model.

It should be noted that the present disclosure does not limit the implementation of the “predicator layer” in the previous paragraph. Additionally, the present disclosure also does not limit the implementation of the step of “performing self-supervised training on the model to be processed” in the previous paragraph.

On the basis of the above case 2 and related content of “self-supervised pre-training” shown in FIG. 2, it can be known that in some application scenarios, self-supervised pre-training may be performed on the backbone network using large-scale image data, such that the pre-trained backbone network has good image feature extraction performance. It can be seen that in a possible implementation, the above model to be processed may include a backbone network and a predicator (Predictor), and input data of the predicator includes output data of the backbone network.

It should be noted that for image 2 and an image 3 shown in FIG. 2, image 2 and the image 3 are both obtained by performing data augmentation on the same image data (e.g., image 1 shown in FIG. 2), but data augmentation parameters used to generate image 2 are different from those used to generate image 3, such that image 2 and image 3 are different in at least one aspect (e.g., color, aspect ratio, size, and image information).

The above “first model” refers to the training result of the above model to be processed, and the backbone network in the first model refers to the result obtained upon training the backbone network in the above model to be processed, such that the backbone network in the first model is used to represent a pre-trained backbone network, thereby enabling the backbone network in the first model to have good image representation performance.

Additionally, the present disclosure does not limit the process of determining the above “first model”. For example, in some application scenarios, the specific process of determining the “first model” may include: performing fully-supervised training (e.g., the training process shown in the part of “fully-supervised pre-training” in FIG. 2) on the model to be processed using the first dataset to obtain the first model. For another example, in some other application scenarios, the specific process of determining the “first model” may include: performing self-supervised training (e.g., the training process shown in the part of “self-supervised pre-training” in FIG. 2) on the model to be processed using the first dataset to obtain the first model.

On the basis of related content in S101 above, it can be known that for the target application field (e.g., the target detection field), in a possible implementation, the large-scale image data (e.g., large-scale single-object image data) may be used to perform fully-supervised or self-supervised pre-training on the backbone network in the image processing model in the target application field, such that the backbone network can fully learn good image representation performance, thereby enabling the pre-trained backbone network to have good image representation performance.

S102: Construct a second model according to the backbone network in the first model, where the second model includes the backbone network and a first processing network, and the first processing network refers to all or part of other networks other than the backbone network in the second model.

The second model refers to a model constructed using the backbone network of the above first model, which may achieve an image processing function (e.g., target detection function, image segmentation function, or key point detection function) required in the above target application field. For example, when the target application field is the target detection field, the second model may refer to a model which is constructed using the backbone network in the first model, and has the target detection function. For another example, when the target application field is the image segmentation field, the second model may refer to a model which is constructed using the backbone network in the first model, and has the image segmentation function. For another example, when the target application field is the key point detection field, the second model may refer to a model which is constructed using the backbone network in the first model, and has the key point detection function.

Actually, for the above second model, the second model may include the first processing network and the backbone network in the above first model. The first processing network refers to all or part of other networks other than the backbone network in the second model. For example, in a possible implementation, the first processing network may be a network subsequent to the backbone network in the second model (e.g., detection head network), such that input data of the first processing network includes output data of the backbone network, thereby enabling the first processing network to process the output data of the backbone network, so as to obtain the output result of the second model (e.g., target detection result, image segmentation result, or key point detection result).

Additionally, the present disclosure does not limit the implementation of the above “first processing network”. For example, the first processing network may include part or all of other networks other than the backbone network in the image processing model in the above target application field. For another example, the first processing network may refer to a network that in the image processing model and is used to process the output data of the backbone network in the image processing model. It can be seen that in a possible implementation, when the target application field is the target detection field, the first processing network may be the detection head network.

It should be noted that the present disclosure does not limit the “detection head network” in the previous paragraph. For example, in some application scenarios, the detection head network may include two networks: Neck and Head. For another example, in some other application scenarios, the detection head network may only include the network Head.

On the basis of related content of the above S102, it can be known that for the target application field (e.g., target detection field, image segmentation field, or key point detection field), upon pre-training on the backbone network is finished, the pre-trained backbone network may be used to construct the image processing model in the target application field, such that the image processing model includes the pre-trained backbone network, thereby the image processing model can be subsequently used to pre-train all of the other networks other than the backbone network in the image processing model.

S103: Train the second model using a second dataset to obtain a model to be used, where the model to be used includes the backbone network and a second processing network, network parameters of the backbone network in the second model are kept unchanged during the training of the second model, the second processing network refers to the training result of the first processing network in the second model, and the second dataset includes at least one second image data.

The second dataset refers to the image dataset required for pre-training part or all of the other networks other than the backbone network in the image processing model in the above target application field.

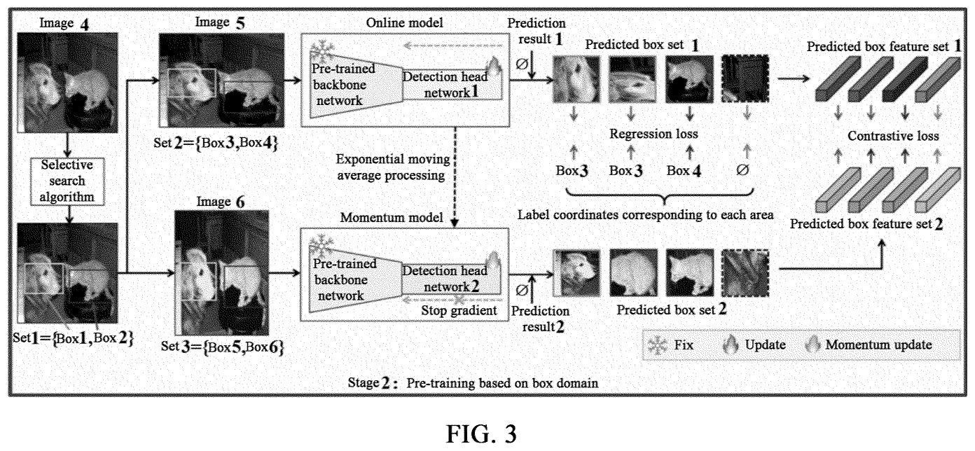

Actually, for the above second dataset, the second dataset may include the at least one second image data. The second image data refers to image data required to be used when pre-training is performed on part or all of the other networks other than the backbone network in the image processing model in the above target application field. In addition, the present disclosure does not limit the second image data. For example, to further improve the pre-training effect, the second image data may belong to multi-object image data (e.g., image 4 shown in FIG. 3, which is multi-object image data), such that at least two objects in the second image data (e.g., two objects, which are a cat and a dog, in image 4).

The above “model to be used” refers to the training result of the above second model, and the model to be used includes the backbone network and the second processing network. Since the network parameters of the backbone network in the second model are constantly kept unchanged during the training of the second model, the backbone network in the model to be used is the above “backbone network in the first model” (i.e., the backbone network pre-trained in the above S101). Since network parameters of all other networks other than the backbone network in the second model are iteratively updated during the training of the second model, the second processing network in the model to be used refers to the training result of the first processing network in the second model, thereby enabling the second processing network to better cooperate with the backbone network to finish the image processing task in the above target application field.

Actually, to further improve the pre-training effect, the present disclosure further provides a process of determining the above “model to be used”, which may specifically include the following step 11 to step 12.

Step 11: Initialize an online model and a momentum model using the above second model.

The online model refers to an image processing model required for reference during pre-training part or all of the other networks other than the backbone network in the image processing model in the above target application field. For example, the online model may refer to the online model shown in FIG. 3.

The momentum model refers to another image processing model required for reference during pre-training part or all of the other networks other than the backbone network in the image processing model in the above target application field. For example, the momentum model may refer to the momentum model shown in FIG. 3.

Additionally, the present disclosure does not limit an association relationship between the above online model and the above momentum model. For example, network parameters in the momentum model may be determined using an exponential moving average processing result of the online model (e.g., the result shown in the formula (1) below).

$${V}_{t} = β \times {V}_{t - 1} + ( 1 - β ) \times {D}_{t} \qquad ( 1 )$$

In the formula, Vₜ represents a parameter value of the network parameter in the momentum model during the t^{th} training round; Vₜ₋₁ represents a parameter value of the network parameter in the momentum model during the (t−1)^{th} training round, and V₀ is a preset value, for example, V₀=0; Dₜ represents a parameter value of the network parameter in the online model during the t^{th} training round, and D₁ refers to a parameter value of the network parameter in the above second model; and β represents a preset coefficient value, for example, β=0.04, and 1−β=0.996.

On the basis of related content of the above step 11, it can be known that upon the above second model is obtained, the second model may be directly determined as an initial value of the online model, such that the parameter value of the network parameter in the initialized online model is kept consistent with the parameter value of the network parameter in the second model; and then, the exponential moving average processing result of the initialized online model is determined as an initial value of the momentum model, such that the parameter value of the network parameter in the initialized momentum model is the exponential moving average processing result of the parameter value of the network parameter in the initialized online model (e.g., the result shown in the above formula (1)), thereby initializing the online model and the momentum model.

It should be noted that for the above step 11, the step 11 may be used to initialize the above online model and the above momentum model to have the same network architecture as the second model, and the initialization process of the network parameters of the momentum model may be performed according to the above formula (1). Additionally, when the network parameters are initialized, backbone network parameters in the momentum model and the online model should be the same as backbone network parameters in the second model, and only network parts other than the backbone need to be initialized.

Step 12: Determine the model to be used according to the above second dataset, the above initialized online model, and the above initialized momentum model.

As an example, step 12 may specifically include step 121 to step 127 below.

Step 121: Select image data to be processed from the at least one second image data.

The image data to be processed refers to any of the above at least one second image data and has not yet participated in the model training process.

Additionally, the present disclosure does not limit the process of determining the above image data to be processed. For example, determining the above image data to be processed may specifically include: screening out all image data that has not yet participated in the model training process from the above at least one second image data; and then, randomly selecting one image data from all the screened image data and determining the image data as the image data to be processed, such that some data processing (e.g., processing processes shown in step 122 to step 123 below) may be performed on the image data to be processed during the current training round.

Step 122: Obtain the object area label corresponding to the above image data to be processed.

The object area label is used to represent the area occupied by each object in the above image data to be processed.

Additionally, the present disclosure does not limit the implementation of the above object area label. For example, in the target detection field, the object area label may be implemented using the object box (e.g., box 1 and box 2 shown in FIG. 3). For another example, in the image segmentation field, the object area label may be implemented using the mask. For another example, in the key point detection field, the object area label may be implemented using the key point position marking box.

Additionally, the present disclosure does not limit the manner for obtaining the above object area label, and for ease of understanding, the description is made with reference two following cases.

Case 1: In some application scenarios (e.g., a scenario with sufficient storage resources), an object area label corresponding to respective second image data may be pre-determined, and the object area labels corresponding to these second image data are stored in a certain storage space, such that the object area label corresponding to certain second image data may be directly read from the storage space in each subsequent training round.

On the basis of the case 1 in the previous paragraph, it can be known that in a possible implementation, the above step 122 may specifically include: looking up the object area label corresponding to the above image data to be processed from a pre-constructed mapping relationship. The mapping relationship includes a correspondence between the second image data and the object area label corresponding to the second image data, and this embodiment of the present disclosure does not limit the mapping relationship, which may be, for example, implemented using a database.

Additionally, the present disclosure does not limit the process of determining an object area label corresponding to i^{th} second image data recorded in the above mapping relationship, which may be, for example, implemented using a manual labeling method. For another example, to better reduce resource consumption, the process of automatically determining the object area label corresponding to the i^{th} second image data may specifically include: using a selective search algorithm to perform object area searching on the i^{th} second image data (e.g., image 4 shown in FIG. 3) to obtain the object area label corresponding to the i^{th} second image data (e.g., {box 1, box 2} shown in FIG. 3), where the selective search algorithm is an unsupervised algorithm, i is a positive integer and is less than or equal to I, I is a positive integer, and I represents the number of images in the above “at least one second image data”.

On the basis of related content of the above case 1, it can be known that in some application scenarios, the object area label corresponding to respective second image data may be pre-determined through an offline mode, and the object area labels corresponding to all the second image data are stored in the storage space through a certain method (e.g., key-value pair method), such that the correspondence between the second image data and the object area label corresponding to the second image data is stored in the storage space in the above mapping relationship manner, thereby subsequently directly reading the object area label corresponding to certain second image data from the storage space during each training round, so as to effectively save resources occupied when determining the object area label corresponding to respective second image data in real time, and then facilitate in improvement in a network training effect.

Case 2: In some application scenarios (e.g., a scenario with limited storage resources), the object area label corresponding to the above image data to be processed may be determined in real time during each training round.

On the basis of the case 2 in the previous paragraph, in a possible implementation, the above step 122 may specifically include: performing object area searching on the above image data to be processed using the above selective search algorithm, to obtain the object area labels corresponding to the image data to be processed.

On the basis of related content of the above step 122, it can be known that for the current training round, upon the image data to be processed is obtained, the object area label corresponding to the image data to be processed may be obtained, thereby the object area label can be used as supervisory information later.

Step 123: Determine at least two image data to be used and object area labels corresponding to the at least two image data to be used according to the image data to be processed and the object area labels corresponding to the image data to be processed.

The image data to be used refers to image data determined when data augmentation processing is performed on the above image data to be processed.

Additionally, for the above “at least two image data to be used”, each image data to be used is a data augmentation processing result of the above image data to be processed, but due to different augmentation parameters used when generating the image data to be used, any two image data from these image data to be used differs in at least one aspect (e.g., color, aspect ratio, size, and image information), such that these image data to be used can represent the same object through different pixel information (e.g., image 5 and image 6 shown in FIG. 3 can represent two objects which are the cat and the dog using the different pixel information).

Additionally, the present disclosure does not limit the implementation of the above “at least two image data to be used”. For example, when the above image data to be processed is image 4 shown in FIG. 3, the “at least two image data to be used” may include image 5 and image 6 shown in FIG. 3.

Additionally, the present disclosure does not limit the number of image data in the “at least two image data to be used”. For example, N image data may be included. N is a positive integer, and is greater than or equal to 2.

The object area labels corresponding to the n^{th} image data to be used are used to represent areas occupied by objects in the n^{th} image data to be used, where n is a positive integer and is less than or equal to N.

Additionally, the present disclosure does not limit the manner for obtaining the above “object area labels corresponding to the n^{th} image data to be used”, which may be, for example, implemented using any existing or future method that may determine an object area for one image data (e.g., manual labeling or the above selective search algorithm).

Actually, to further improve the model training effect, the present disclosure further provides a possible implementation for the process of determining the above “object area labels corresponding to the n^{th} image data to be used”. In this implementation, when the n^{th} image data to be used is determined by performing data augmentation processing on the above image data to be processed according to a certain augmentation parameter, the specific process of determining the “object area labels corresponding to the n^{th} image data to be used” may include: performing data augmentation processing on object area labels corresponding to the image data to be processed according to the augmentation parameter to obtain object area labels corresponding to the n^{th} image data to be used, such that the “object area labels corresponding to the n^{th} image data to be used” can represent the areas occupied by respective objects in the n^{th} image data to be used.

It should be noted that the present disclosure does not limit the process of determining information about “an augmentation parameter used when generating the n^{th} image data to be used” in the previous paragraph, which may be, for example, randomly determined, or may also be preset.

On the basis of related content of the above step 123, it can be known that after the above image data to be processed (e.g., the image 4 shown in FIG. 3) and the object area labels corresponding to the image data to be processed (e.g., {box 1, box 2} shown in FIG. 3) are obtained, N times of different data augmentation processing may be performed on the image data to be processed, and each data augmentation processing is determined as the image data to be used (e.g., the image 5 or the image 6 shown in FIG. 3). Meanwhile, the object area labels corresponding to the image data to be processed correspondingly change with each data augmentation processing, thereby obtaining the object area labels corresponding to the image data to be used (e.g., {box 3, box 4} or {box 5, box 6} shown in FIG. 3), so as to continue performing the current training round according to these image data to be used and the corresponding object area labels.

Step 124: Determine object area prediction results corresponding to the at least two image data to be used using the online model and the momentum model.

An object area prediction result corresponding to the n^{th} image data to be used refers to a result determined by the model when performing object area prediction on the n^{th} image data to be used, where n is a positive integer and is less than or equal to N.

Additionally, the present disclosure does not limit the implementation of the above object area prediction results. For example, the above “object area prediction result corresponding to the n^{th} image data to be used” may include at least one predicted area representation data (e.g., various object boxes in a box set 1 shown in FIG. 3) and predicted area features corresponding to the at least one predicted area representation data (e.g., various box features in a box feature set 1 shown in FIG. 3), where e^{th} predicted area representation data is used to represent an area occupied by an e^{th} object in the n^{th} image data to be used. Predicted area features corresponding to the e^{th} predicted area representation data are used to represent features presented by the e^{th} predicted area representation data, where e is a positive integer and is less than or equal to E, and E represents the number of data in the “at least one predicted area representation data”.

Additionally, the present disclosure does not limit the implementation of the above step 124, and for ease of understanding, a description is made with reference to following examples.

As an example, when the above “at least two image data to be used” includes at least one third image data and at least one fourth image data, step 124 may specifically include step 1241 to step 1242 below.

Step 1241: Determine an object area prediction result corresponding to each third image data using the above online model.

The third image data refers to image data to be used for object area prediction by the above online model. For example, the third image data may refer to image 5 shown in FIG. 3.

An object area prediction result corresponding to j^{th} third image data refers to a result determined by the above online model when performing object area prediction on the j^{th} third image data, where j is a positive integer and is less than or equal to J, J is a positive integer, and J represents the number of image data in the above “at least one third image data”.

Additionally, the present disclosure does not limit the process of determining the above “object area prediction result corresponding to j^{th} third image data”, which may specifically, for example, include: inputting the j^{th} third image data (e.g., image 5 shown in FIG. 3) to the above online model, to obtain the object area prediction result that corresponds to the j^{th} third image data and is output by the online model (e.g., the box set 1 and the box feature set 1 shown in FIG. 3).

Step 1242: Determine an object area prediction result corresponding to each fourth image data using the above momentum model.

The fourth image data refers to image data to be used, which is required for object area prediction by the above momentum model. For example, the fourth image data may refer to the image 6 shown in FIG. 3.

An object area prediction result corresponding to m^{th} fourth image data refers to a result determined by the above online model when performing object area prediction on the m^{th} fourth image data, where m is a positive integer and is less than or equal to M, M is a positive integer, and M represents the number of image data in the above “at least one fourth image data”. It should be noted that N=M+J as above.

Additionally, the present disclosure does not limit the process of determining the above “object area prediction result corresponding to m^{th} fourth image data”, which may specifically, for example, include: inputting the m^{th} fourth image data (e.g., image 6 shown in FIG. 3) to the above momentum model, to obtain the object area prediction result that corresponds to the m^{th} fourth image data and is output by the momentum model (e.g., box set 2 and box feature set 2 shown in FIG. 3).

Based on related content from the above step 1241 to the above step 1242, it can be known that for the above at least two image data to be used, these image data to be used may be divided into two parts, one part of image data (e.g., image 5 shown in FIG. 3) is input to the above online model, thereby obtaining the prediction result output by the online model; but, the other part of image data (e.g., image 6 shown in FIG. 3) is input to the above momentum model, thereby obtaining the prediction result output by the momentum model, so as to perform object area prediction on these image data to be used through the online model and the momentum model.

It should be noted that the present disclosure does not limit the process of determining the image data input to the above online model (i.e., the above J third image data), which may specifically, for example, include: randomly selecting J image data from these image data to be used after obtaining the above “at least two image data to be used”, and using the selected image data as the third image data, thereby subsequently inputting the selected image data to the online model. Additionally, the present disclosure also does not limit the process of determining the image data of the above momentum model (i.e., the above M fourth image data), which may specifically, for example, include: using the remaining image data as the fourth image data after randomly selecting J image data from these image data to be used, and inputting the remaining image data to the momentum model.

On the basis of related content of the above step 124, it can be known that after the image data to be used is obtained, the image data to be used may be respectively input to the corresponding model (e.g., the online model or the momentum model), such that the model can obtain the prediction results obtained after predication for the image data to be used (e.g., the object area prediction results corresponding to the image data to be used), thereby subsequently using these prediction results to determine model prediction performance of the online model.

Step 125: Determine whether a preset stopping condition is met, where if yes, perform step 127 below, and if not, perform step 126 below.

The preset stopping condition refers to a training stopping condition required for reference during pre-training part or all of the other networks other than the backbone network in the image processing model in the above target application field. The present disclosure does not limit the preset stopping condition, which may include, for example, the number of iterations in the training process reaching a preset time threshold. For another example, the preset stopping condition may include: a model loss of the above online model being lower than a preset loss threshold. For another example, the preset stopping condition may include: a rate of change of the model loss of the online model being lower than a preset rate of change threshold (i.e., the online model tends to converge).

The above “model loss of the online model” is used to represent the model prediction performance of the online model, and the present disclosure does not limit the process of determining the “model loss of the online model”.

Actually, to further improve the model training effect, the present disclosure further provides a possible implementation of the process of determining the above “model loss of the online model”. In the implementation, when the above “at least two image data to be used” includes at least one third image data and at least one fourth image data, the specific process of determining the “model loss of the online model” may include step 21 to step 23 below.

Step 21: Determine a regression loss corresponding to the online model according to the object area prediction result corresponding to the above at least one third image data and object area labels corresponding to the at least one third image data.

Object area labels corresponding to the j^{th} third image data are used to represent areas occupied by respective objects in the j^{th} third image data, where j is a positive integer and is less than or equal to J.

The above “regression loss corresponding to the online model” is used to represent regression features of the online model in the regression task during the current training round. The regression task specifically includes: inputting one image data to the online model, and then keeping the object area prediction result output by the online model for the image data consistent with the object area labels corresponding to the image data as much as possible. For example, the “regression loss corresponding to the online model” may be a regression loss shown in FIG. 3.

Additionally, the present disclosure does not limit the process of determining the above “regression loss corresponding to the online model”. For example, when the above “object area prediction result” includes at least one predicted area representation data (e.g., each object box in the box set 1 shown in FIG. 3), the specific process of determining the “regression loss corresponding to the online model” may include: performing regression loss calculation processing on at least one predicted area representation data corresponding to the above at least one third image data and object area labels corresponding to the at least one third image data according to a preset regression loss calculation formula, thereby obtaining the regression loss corresponding to the online model, to allow the regression loss to represent the regression features of the online model.

It should be noted that the present disclosure does not limit the implementation of the regression loss calculation formula in the previous paragraph, which may be, for example, implemented using any existing or future regression loss calculation method, or may also be implemented using a regression loss calculation method set according to practical application scenarios.

Step 22: Determine a contrastive loss corresponding to the online model according to the object area prediction result corresponding to the above at least one third image data and the object area prediction result corresponding to the above at least one fourth image data.

The contrastive loss corresponding to the online model (e.g., the contrastive loss shown in FIG. 3) is used to represent classification features of the online model in the classification task during the current training round. The classification task is a self-supervised classification task, and may be implemented using contrastive learning.

Additionally, the present disclosure does not limit the process of determining the above “contrastive loss corresponding to the online model”. For example, in a possible implementation, when the above object area label includes at least one target area representation data and the above object area prediction result includes at least one predicted area feature (e.g., the box feature set 1 or the box feature set 2 shown in FIG. 3) and predicted area representation data corresponding to the at least one predicted area feature (e.g., the box set 1 or the box set 2 shown in FIG. 3), the specific process of determining the “contrastive loss corresponding to the online model” may include step 31 to step 33 below.

Step 31: Obtain a correspondence between at least one target area representation data corresponding to the j^{th} third image data and at least one target area representation data corresponding to the m^{th} fourth image data, where j is a positive integer and is less than or equal to J, and m is a positive integer and is less than or equal to M.

k^{th} target area representation data corresponding to the j^{th} third image data is used to represent the area occupied by the k^{th} object in the j^{th} third image data, thereby enabling the “k^{th} target area representation data corresponding to the j^{th} third image data” to represent the area label corresponding to the k^{th} object, where k is a positive integer and is less than or equal to K, K is a positive integer, and K represents the number of data in the above “at least one target area representation data corresponding to the j^{th} third image data”.

Additionally, the present disclosure does not limit the above “at least one target area representation data corresponding to the j^{th} third image data”. For example, when the j^{th} third image data is the image 5 shown in FIG. 3, the “at least one target area representation data corresponding to the j^{th} third image data” may include the box 3 and the box 4 shown in FIG. 3.

Meanwhile, h^{th} target area representation data corresponding to the m^{th} fourth image data is used to represent the area occupied by the h^{th} object in the mt fourth image data, thereby enabling the “h^{th} target area representation data corresponding to m^{th} fourth image data” to represent an area label of the h^{th} object, where h is a positive integer and is less than or equal to H, and H is a positive integer and represents the number of data in the above “at least one target area representation data corresponding to the m^{th} fourth image data”.

Additionally, the present disclosure does not limit the above “at least one target area representation data corresponding to the m^{th} fourth image data”. For example, when the m^{th} fourth image data is the image 6 shown in FIG. 3, the “at least one target area representation data corresponding to the m^{th} fourth image data” may include the box 5 and the box 6 shown in FIG. 3.

Additionally, the present disclosure does not limit the implementation of the above step 31, which may specifically, for example, include: reading the correspondence between the at least one target area representation data corresponding to the j^{th} third image data and the at least one target area representation data corresponding to the m^{th} fourth image data from a preset storage space.

For another example, in a possible implementation, the above step 31 may specifically include step 311 to step 313 below.

Step 311: Obtain a correspondence between at least one target area representation data corresponding to the above j^{th} third image data and at least one target area representation data corresponding to the above image data to be processed as a first correspondence.

The d^{th} target area representation data corresponding to the image data to be processed is used to represent the area occupied by the d^{th} object in the image data to be processed, thereby enabling the “d^{th} target area representation data corresponding to the image data to be processed” to represent the area label corresponding to the d^{th} object. Meanwhile, d is a positive integer and is less than or equal to D, and D is a positive integer and represents the number of data in the above “at least one target area representation data corresponding to the image data to be processed”.

Additionally, the present disclosure does not limit the above “at least one target area representation data corresponding to the image data to be processed”. For example, when the image data to be processed is the image 4 shown in FIG. 3, the “at least one target area representation data corresponding to the image data to be processed” may include the box 1 and the box 2 shown in FIG. 3.

Additionally, the present disclosure does not limit the implementation of step 311, which may specifically, for example, include: determining that there is a correspondence between the “k^{th} target area representation data corresponding to the j^{th} third image data” and the “d^{th} target area representation data corresponding to the image data to be processed” if the above “k^{th} target area representation data corresponding to the j^{th} third image data” is determined by making a certain change to the above “d^{th} target area representation data corresponding to the image data to be processed”; and determining that there is no correspondence between the “k^{th} target area representation data corresponding to the j^{th} third image data” and the “d^{th} target area representation data corresponding to the image data to be processed” if the “k^{th} target area representation data corresponding to the j^{th} third image data” is not determined by making a certain change to the “dh target area representation data corresponding to the image data to be processed”, where k is a positive integer and is less than or equal to K, and d is a positive integer and is less than or equal to D.

Step 312: Obtain a correspondence between at least one target area representation data corresponding to the above m^{th} fourth image data and at least one target area representation data corresponding to the above image data to be processed as a second correspondence.

It should be noted that the implementation of step 312 is similar to the implementation of the above step 311, and which may specifically, for example, include: determining that there is a correspondence between the “h^{th} target area representation data corresponding to the m^{th} fourth image data” and the “d^{th} target area representation data corresponding to the image data to be processed” if the above “h^{th} target area representation data corresponding to the m^{th} fourth image data” is determined by making a certain change to the above “d^{th} target area representation data corresponding to the image data to be processed”; and determining that there is no correspondence between the “h^{th} target area representation data corresponding to the m^{th} fourth image data” and the “d^{th} target area representation data corresponding to the image data to be processed” if the “h^{th} target area representation data corresponding to the m^{th} fourth image data” is not determined by making a certain change to the “d^{th} target area representation data corresponding to the image data to be processed”, where h is a positive integer and is less than or equal to H, and d is a positive integer and is less than or equal to D.

Step 313: Determine a correspondence between the at least one target area representation data corresponding to the above j^{th} third image data and the at least one target area representation data corresponding to the m^{th} fourth image data according to the above first correspondence and the above second correspondence.

It should be noted that the present disclosure does not limit the implementation of the above step 313, which may be, for example, implemented using a correspondence transfer process. It can be seen that in a possible implementation, step 313 may specifically include: determining that the “k^{th} target area representation data corresponding to the j^{th} third image data” and the “h^{th} target area representation data corresponding to the m^{th} fourth image data” correspond to the same object in the image data to be processed if the above first correspondence represents that there is a correspondence between the above “k^{th} target area representation data corresponding to the j^{th} third image data “and the above “d^{th} target area representation data corresponding to the image data to be processed”, and the above second correspondence represents that there is a correspondence between the above “h^{th} target area representation data corresponding to the m^{th} fourth image data” and the “d^{th} target area representation data corresponding to the image data to be processed”, so as to determine that there is a correspondence between the “k^{th} target area representation data corresponding to the j^{th} third image data “and the “h^{th} target area representation data corresponding to the m^{th} fourth image data”.

However, if the above first correspondence represents that there is a correspondence between the above “k^{th} target area representation data corresponding to the j^{th} third image data “and the above “d^{th} target area representation data corresponding to the image data to be processed”, but the above second correspondence represents that there is no correspondence between the above “h^{th} target area representation data corresponding to the m^{th} fourth image data” and the “d^{th} target area representation data corresponding to the image data to be processed”, it may be determined that the “k^{th} target area representation data corresponding to the j^{th} third image data” and the “h^{th} target area representation data corresponding to the m^{th} fourth image data” correspond to different objects in the image data to be processed, so as to determine that there is no correspondence between the “k^{th} target area representation data corresponding to the j^{th} third image data” and the “h^{th} target area representation data corresponding to the m^{th} fourth image data”.

On the basis of related content of the above step 31, it can be known that after the above at least one third image data and the at least one fourth image data are obtained, the correspondence between the at least one target area representation data corresponding to each third image data (e.g., the box 3 and the box 4 shown in FIG. 3) and the at least one target area representation data corresponding to each fourth image data (e.g., the box 5 and the box 6 shown in FIG. 3), thereby subsequently determining, based on the correspondence, the contrastive loss between the prediction result of the at least one third image data and the prediction result of the at least one fourth image data.

Step 32: Determine, based on the above correspondence, a positive sample and a negative sample for respective predicted area features corresponding to the above at least one third image data from at least one predicted area feature corresponding to the above at least one fourth image data.

The h^{th} predicted area representation data corresponding to the m^{th} fourth image data is used to represent the area predicted for the h^{th} object in the m^{th} fourth image data, and h is a positive integer and is less than or equal to H.

The h^{th} predicted area feature corresponding to the m^{th} fourth image data is used to represent features of the above “h^{th} predicted area representation data corresponding to the m^{th} fourth image data”, and h is a positive integer and is less than or equal to H.

The k^{th} predicted area representation data corresponding to the j^{th} third image data is used to represent the area predicted for the k^{th} object in the j^{th} third image data, where k is a positive integer and is less than or equal to K.

A k^{th} predicted area feature corresponding to the j^{th} third image data is used to represent features of the above “k^{th} predicted area representation data corresponding to the j^{th} third image data”, where k is a positive integer and is less than or equal to K.

A positive sample of the k^{th} predicted area feature corresponding to the j^{th} third image data refers to a predicted area feature in the object area prediction result of any fourth image data, and has a correspondence with a predicted area represented by the predicted area feature, where k is a positive integer and is less than or equal to K.

A negative sample of the k^{th} predicted area feature corresponding to the j^{th} third image data refers to a predicted area feature in the object area prediction result of any fourth image data, and does not have a correspondence with the predicted area represented by the predicted area feature, where k is a positive integer and is less than or equal to K.

Additionally, the present disclosure does not limit the implementation of the above step 32. For example, the step 32 may specifically include step 321 to step 322 below.

Step 321: If the above correspondence represents that there is a correspondence between the above “h^{th} target area representation data corresponding to the m^{th} fourth image data” and the above “k^{th} target area representation data corresponding to the j^{th} third image data”, then the “h^{th} predicted area feature corresponding to the m^{th} fourth image data” having the correspondence with the “h^{th} target area representation data corresponding to the m^{th} fourth image data” may be determined as the positive sample of the above “k^{th} predicted area feature corresponding to the j^{th} third image data”, where h is a positive integer and is less than or equal to H, and k is a positive integer and is less than or equal to K.

In the present disclosure, if the above correspondence represents that there is the correspondence between the above “h^{th} target area representation data corresponding to the m^{th} fourth image data” and the above “k^{th} target area representation data corresponding to the j^{th} third image data”, it may be determined that the “h^{th} target area representation data corresponding to the m^{th} fourth image data” and the “k^{th} target area representation data corresponding to the j^{th} third image data” correspond to the same object in the above image data to be processed, thereby determining that the prediction result corresponding to the “h^{th} target area representation data corresponding to the m^{th} fourth image data” (e.g., predicted area representation data and corresponding predicted area features), and the prediction result corresponding to the “k^{th} target area representation data corresponding to the j^{th} third image data” are both predicted for the same object, so as to determine that the previous prediction result is the positive sample for the latter prediction result, and then the predicted area feature in the previous prediction result (i.e., the above “hi predicted area feature corresponding to the m^{th} fourth image data”) may be determined as the positive sample for the predicted area feature in the latter prediction result (i.e., the above “k^{th} predicted area feature corresponding to the j^{th} third image data”).

Step 322: If the above correspondence represents that there is no correspondence between the above “h^{th} target area representation data corresponding to the m^{th} fourth image data” and the above “k^{th} target area representation data corresponding to the j^{th} third image data”, then the “hi predicted area feature corresponding to the m^{th} fourth image data” having the correspondence with the “h^{th} target area representation data corresponding to the m^{th} fourth image data” may be determined as the positive sample of the above “km predicted area feature corresponding to the j^{th} third image data”, where h is a positive integer and is less than or equal to H, and k is a positive integer and is less than or equal to K.

In the present disclosure, if the above correspondence represents that there is no correspondence between the above “h^{th} target area representation data corresponding to the mt fourth image data” and the above “k^{th} target area representation data corresponding to the j^{th} third image data”, it may be determined that the “h^{th} target area representation data corresponding to the m^{th} fourth image data” and the “k^{th} target area representation data corresponding to the j^{th} third image data” correspond to different objects in the above image data to be processed, thereby determining that the prediction result corresponding to the “h^{th} target area representation data corresponding to the m^{th} fourth image data” (e.g., predicted area representation data and corresponding predicted area features), and the prediction result corresponding to the “k^{h} target area representation data corresponding to the j^{th} third image data” are predicted for different objects, so as to determine that the previous prediction result is the negative sample for the latter prediction result, and then the predicted area feature in the previous prediction result (i.e., the above “hi predicted area feature corresponding to the m^{th} fourth image data”) may be determined as the negative sample for the predicted area feature in the latter prediction result (i.e., the above “k^{th} predicted area feature corresponding to the j^{th} third image data”).

On the basis of related content of step 321 to step 322 above, in a possible implementation, for any third image data, when at least one predicted area feature corresponding to the third image data includes an area feature to be used (e.g., the above “k^{th} predicted area feature corresponding to the j^{th} third image data”) and the area feature to be used is used to represent any predicted area feature corresponding to the third image data, a positive sample and a negative sample of the area feature to be used respectively meet conditions shown in Q to \textcircled{2} as below.

\textcircled{1} There is a correspondence between target area representation data corresponding to a positive sample of the above area feature to be used and target area representation data corresponding to the area feature to be used.

The above “target area representation data corresponding to a positive sample of the area feature to be used” refers to an area label of an object corresponding to the positive sample in the above fourth image data. For example, when the area feature to be used is the above “k^{h} predicted area feature corresponding to the j^{th} third image data” and the positive sample of the area feature to be used is the above “h^{th} predicted area feature corresponding to the mt fourth image data”, the “target area representation data corresponding to a positive sample of the area feature to be used” refers to the above “hi target area representation data corresponding to the m^{th} fourth image data”.

Additionally, the present disclosure does not limit the process of determining the above “target area representation data corresponding to a positive sample of the area feature to be used”, which may specifically, for example, include: determining the target area representation data corresponding to the positive sample according to a size of an overlapping area between the predicted area representation data corresponding to the positive sample and various target area representation data corresponding to the fourth image data to which the positive sample belongs, thereby maximizing the size of the overlapping area between the predicted area representation data corresponding to the positive sample and the target area representation data corresponding to the positive sample. The “predicted area representation data corresponding to the positive sample” refers to an area prediction result of an object corresponding to the positive sample in the above fourth image data (e.g., the above “h^{th} predicted area representation data corresponding to the m^{th} fourth image data”).

The above “target area representation data corresponding to the area feature to be used” refers to an area label of an object corresponding to the area feature to be used in the above third image data. For example, when the area feature to be used is the above “k^{th} predicted area feature corresponding to the j^{th} third image data”, the “target area representation data corresponding to the area feature to be used” refers to the above “k^{th} target area representation data corresponding to the j^{th} third image data”.

It should be noted that the process of obtaining the above “target area representation data corresponding to the area feature to be used” is similar to the process of obtaining the above “target area representation data corresponding to a positive sample of the area feature to be used”, and for brevity, is not repeated herein.

It can be seen that in a possible implementation, the process of obtaining the above “target area representation data corresponding to the area feature to be used” may specifically include: determining the target area representation data corresponding to the area feature to be used according to a size of an overlapping area between the predicted area representation data corresponding to the area feature to be used and various target area representation data corresponding to the third image data to which the area feature to be used belongs, thereby maximizing the size of the overlapping area between the predicted area representation data corresponding to the area feature to be used and the target area representation data corresponding to the area feature to be used. The “predicted area representation data corresponding to the area feature to be used” refers to the area prediction result of the object corresponding to the area feature to be used in the above third image data.

\textcircled{2} There is no correspondence between target area representation data corresponding to a negative sample of the above area feature to be used and target area representation data corresponding to the area feature to be used.

The above “target area representation data corresponding to a negative sample of the area feature to be used” refers to an area label of an object corresponding to the negative sample in the above fourth image data. For example, when the area feature to be used is the above “k^{th} predicted area feature corresponding to the j^{th} third image data” and the negative sample of the area feature to be used is the above “h^{th} predicted area feature corresponding to the mt fourth image data”, the “target area representation data corresponding to a negative sample of the area feature to be used” refers to the above “hi target area representation data corresponding to the m^{th} fourth image data”.

It should be noted that the process of obtaining the above “target area representation data corresponding to a negative sample of the area feature to be used” is similar to the process of obtaining the above “target area representation data corresponding to a positive sample of the area feature to be used”, and for brevity, is not repeated herein.

It can be seen that in a possible implementation, the process of obtaining the “target area representation data corresponding to a negative sample of the area feature to be used” may specifically include: determining a size of an overlapping area between the predicted area representation data corresponding to the negative sample and various target area representation data corresponding to the fourth image data to which the negative sample belongs, thereby maximizing the size of the overlapping area between the predicted area representation data corresponding to the negative sample and the target area representation data corresponding to the positive sample. The “predicted area representation data corresponding to the negative sample” refers to the area prediction result of the object corresponding to the negative sample in the above fourth image data.

On the basis of related content of the above step 32, after obtaining the correspondence between the at least one target area representation data corresponding to the above j^{th} third image data and the at least one target area representation data corresponding to the above m^{th} fourth image data, prediction results of the target area representation data corresponding to the same object in the two image data (e.g., the predicted area features) are determined as the positive samples, and the prediction results of the target area representation data corresponding to different objects in the two image data are determined as the negative samples, thereby subsequently determining the contrastive loss between the prediction results of the two image data using the positive samples and the negative samples, where j is a positive integer and is less than or equal to J, m is a positive integer and is less than or equal to M.

Step 33: Determine a contrastive loss corresponding to the above online model according to the at least one predicted area feature corresponding to the above at least one third image data, and the positive sample and the negative sample of respective predicted area features corresponding to the at least one third image data.

It should be noted that the present disclosure does not limit the implementation of step 33, which may be, for example, implemented using any existing or future method for determining a contrastive loss.

On the basis of related content of step 31 to step 33 above, in a possible implementation, after obtaining the object area prediction result (e.g., the box set 1 and the box feature set 1 shown in FIG. 3) corresponding to the at least one third image data output by the above online model and the object area prediction result (e.g., the box set 2 and the box feature set 2 shown in FIG. 3) corresponding to the at least one fourth image data output by the above momentum model, the contrastive loss corresponding to the online model may be determined using a contrastive learning method, thereby enabling the contrastive loss to represent classification performance of the online model.

Step 23: Determine a model loss of the above online model according to the above regression loss and the above contrastive loss.

It should be noted that the present disclosure does not limit the implementation of step 23, which may be, for example, implemented using any existing or future method that may integrate two losses (e.g., processing method such as weighted summation and aggregation).

On the basis of related content of step 21 to step 23 above, upon obtaining the object area prediction result corresponding to the at least one third image data output by the above online model and the object area prediction result corresponding to the at least one fourth image data output by the above momentum model, the regression loss and the contrastive loss of the online model may be first determined by respectively using these object area prediction results; and based on the two losses, the model loss of the online model is determined, thereby enabling the model loss to better represent prediction loss of the online model (e.g., prediction performance of an area occupied by an object, and classification performance).

On the basis of related content of the above step 125, in a possible implementation, for the current training round, after obtaining the object area prediction result corresponding to the at least one third image data output by the above online model and the object area prediction result corresponding to the at least one fourth image data output by the above momentum model, the model loss of the online model may be first determined using these object area prediction results, thereby enabling the model loss to represent the prediction performance of the online model; and then whether the model loss reaches a preset loss condition is determined, where if the preset loss condition is met, it may be determined that the online model has good prediction performance, and therefore it may be determined that the above preset stopping condition has been met, thereby continuing performing step 127 below; and if the preset loss condition is not met, it may be determined that the prediction performance of the online model is not good, and therefore it may be determined that the above preset stopping condition is not met, thereby continuing performing step 126 below. The preset loss condition is preset, which may specifically, for example, include: the model loss being lower than a preset loss threshold, or may also include: a rate of change of the model loss being lower than a preset rate of change threshold.

Step 126: When it is determined that the preset stopping condition is not met, update the online model and the momentum model according to the object area prediction results corresponding to the above at least two image data to be used and the object area labels corresponding to the at least two image data to be used, and continue performing the above step 121 and subsequent steps.

It should be noted that the present disclosure does not limit the process of updating the above online model. For example, when the above “at least two image data to be used” includes at least one third image data and at least one fourth image data, the process of updating the online model may include step 41 to step 43 below.

Step 41: Determine a regression loss corresponding to the above online model according to the object area prediction result corresponding to the above at least one third image data and object area labels corresponding to the at least one third image data.

It should be noted that for related content of step 41, reference is made to the above step 21, and for brevity, is not repeated herein.

Step 42: Determine a contrastive loss corresponding to the above online model according to the object area prediction result corresponding to the above at least one third image data and the object area prediction result corresponding to the above at least one fourth image data.

It should be noted that for related content of step 42, reference is made to the above step 22, and for brevity, is not repeated herein.

Step 43: Update the above online model according to the above regression loss and the above contrastive loss.

It should be noted that the present disclosure does not limit the implementation of step 43. For example, when the above online model includes the backbone network and the first processing network, step 43 may specifically include: updating network parameters of the first processing network in the online model according to the above regression loss and the above contrastive loss so as to fix network parameters of the backbone network and updating network parameters of other networks other than the backbone network in the online model.

It should also be noted that the present disclosure does not limit a method for updating the “network parameters” in the previous paragraph, which may be, for example, implemented using any existing or future method that may perform network parameter update processing based on the model loss (e.g., gradient update).

On the basis of related content of step 41 to step 43 above, it can be known that in a possible implementation, when it is determined that the preset stopping condition is not met, the model loss of the above online model may be determined according to the object area prediction results corresponding to the above at least two image data to be used and the object area labels corresponding to the at least two image data to be used; and then, gradient update is performed on the network parameters of all other networks other than the backbone network in the online model, such that the updated online model is obtained, thereby keeping the network parameters of the backbone network in the updated online model consistent with the network parameters of the backbone network in the online model before update, so as to update the network parameters of the other networks other than the backbone network in the online model.

Additionally, the present disclosure does not limit the process of updating the above momentum model, which may specifically, for example, include: using the updated online model to update the momentum model. It can be seen that in a possible implementation, for the current training round, after obtaining the updated online model, an exponential moving average processing result of the updated online model (e.g., the result shown in the above formula (1)) may be determined as the updated momentum model.

Actually, to further improve the model training effect, the present disclosure further provides a possible implementation of the above step of “using the updated online model to update the momentum model”, which may specifically include: updating network parameters of the first processing network in the momentum model (e.g., determining the exponential moving average processing result of the network parameters of the first processing network in the updated online model as the network parameters of the first processing network in the updated momentum model) according to the network parameters of the first processing network in the updated online model, thereby updating the network parameters of the other networks other than the backbone network in the momentum model.

On the basis of the content in the previous paragraph and the above formula (1), it can be known that in a possible implementation, upon obtaining the above updated online model, weighted summation processing may be performed on the network parameters of the first processing network in the momentum model before update and the network parameters of the first processing network in the updated online model, thereby obtaining the network parameters of the first processing network in the updated momentum model. It should be noted that for related content of weights involved in the weighted summation processing, reference is made to the related content of the weights involved in the above (1), and for brevity, is not repeated herein.

On the basis of related content of the above step 126, it can be known that for the current training round, when it is determined that the preset stopping condition is not met, it may be determined that the prediction performance of the above online model still needs to be continuously improved, and therefore the online model and the momentum model may be first updated according to the object area prediction results corresponding to the above at least two image data to be used and the object area labels corresponding to the at least two image data to be used, so as to obtain the updated online model and the updated momentum model, thereby enabling the two models to have better prediction performance; and then the updated online model and the updated momentum model are used to return and continue performing the above step 121 and subsequent steps, so as to start the next training round, and the iterative process continues until the preset stopping condition is met.

Step 127: Determine a model to be used according to the above online model when it is determined that the preset stopping condition is met.

In the present disclosure, for the current training round, when it is determined that the preset stopping condition is met, it may be determined that the above online model has good prediction performance, and therefore the model to be used may be directly determined according to the online model (e.g., directly determining the online model used in the last training round as the model to be used), such that the model to be used has good prediction performance, thereby pre-training the image processing model in the target application field.

On the basis of related content of step 121 to step 127 above, it can be known that in a possible implementation, when the above target application field is the target detection field, the above second dataset may include a plurality of multi-object image data, and for any multi-object image data (e.g., image 4 shown in FIG. 3), target boxes of the multi-object image data (e.g., the box 1 and the box 2 shown in FIG. 3) may be first determined through the selective search algorithm; then, N augmented images (e.g., image 5 and image 6 shown in FIG. 3) of the multi-object image data are obtained through N times of different data augmentations (e.g., N=2 shown in FIG. 3), and coordinates of the target boxes of the multi-object image data correspondingly change along with the data augmentation process, so as to obtain target boxes of these augmented images, thereby subsequently using these target boxes as pseudo-labels for these augmented images; then, a part of these augmented images are input to the online model, and the other part is input to the momentum model, thereby obtaining model prediction results of these augmented images; then, the model loss of the online model is determined according to the model prediction results of these augmented images and the target boxes of these augmented images; and then, the model loss is used to perform gradient update on the network parameters of the other networks other than the backbone network in the online model, and the exponential moving average processing result of the updated online model is used to update the momentum model, thereby subsequently continuing performing the next training round based on the updated online model and the updated momentum model.

Additionally, according to the present disclosure, classification features and regression features represented by the above online model on these augmented images may be determined according to the model prediction results of these augmented images and the target boxes of these augmented images, and therefore, in the present disclosure, a self-supervised classification task may be constructed based on the classification features, and in the classification task, typically, the prediction results corresponding to the same target box may be regarded as positive samples, and the prediction results corresponding to different target boxes are regarded as negative samples, thereby constructing contrastive learning. Meanwhile, according to the present disclosure, the regression task may also be constructed, and the objective of the regression task is to keep coordinates of a prediction box obtained after prediction for the augmented image consistent with the target box of the augmented image so as to achieve the regression purpose. It can be seen that based on the two tasks, the present disclosure may pre-train the other networks other than the Backbone in the target detection model through an unsupervised method, such that when the above Backbone is pre-trained using the self-supervised method, the pre-training of all networks of any target detection model can be achieved through the unsupervised method.

On the basis of related content of S101 to S103 above, for the machine learning model (e.g., the target detection model, the semantic segmentation model, or the key point detection model) used in some image processing fields, the first dataset (e.g., a large amount of single-object image data) is first used to train the model to be processed to obtain the first model, such that the backbone network in the first model has a good image feature extraction function, thereby achieving the pre-training of the backbone network in the machine learning model; then, the second model is constructed according to the backbone network in the first model, such that the image processing function achieved by the second model is kept consistent with the image processing function to be achieved by the machine learning model; and then, the second dataset (e.g., some multi-object image data) is used to train the second model, and the network parameters of the backbone network in the second model are constantly kept unchanged in the training process of the second model, such that when the trained second model is determined as the model to be used, the backbone network in the model to be used is kept consistent with the backbone network in the first model, and the second processing network in the model to be used refers to the training result of the first processing network in the second model, thus the other networks in the machine learning model can be pre-trained on the premise of fixing the backbone network, the well-constructed image processing model (e.g., the target detection model) with good image processing performance can be obtained by subsequently fine-tuning the model to be used, and the construction processing on the machine learning model in these image processing fields can be achieved accordingly.

Additionally, the method for constructing the model provided in the present disclosure not only pre-trains the backbone network in the above image processing model (e.g., the target detection model), but also pre-trains the other networks other than the backbone network in the image processing model (e.g., the detection head network), and therefore all networks in the final pre-trained model have good data processing performance, thereby effectively avoiding adverse effects caused by only performing pre-training on the backbone network, so as to effectively improve the image processing effect (e.g., the target detection effect) of the final constructed image processing model.

Additionally, the method for constructing the model provided in the present disclosure not only uses the single-object image data for model pre-training, but also uses the multi-object image data for the model pre-training, such that the finally pre-trained model has a good image processing function for the multi-object image data, thereby effectively avoiding adverse effects caused by performing model pre-training only using the single-object image data, so as to effectively improve the image processing effect (e.g., the target detection effect) of the final constructed image processing model.

Further, the method for constructing the model provided in the present disclosure not only focuses on the classification task but also focuses on the regression task, such that the final pre-trained model has good image processing performance, thereby effectively avoiding adverse effects caused by only focusing on the classification task for pre-training, so as to effectively improve the image processing effect (e.g., the target detection effect) of the final constructed image processing model.

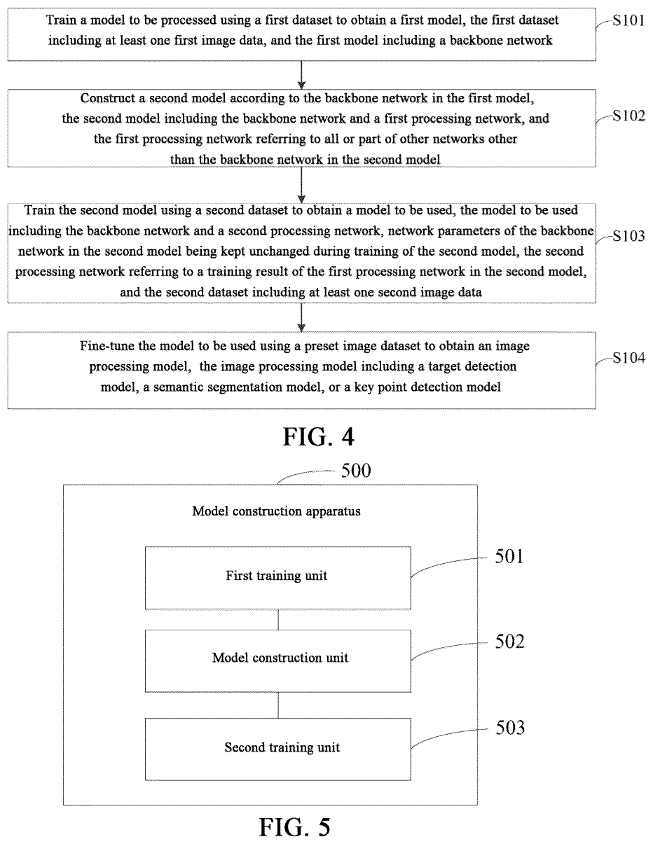

Actually, On the basis of related content of the above model construction method, the above S101 to S103 provide a pre-training process. Therefore, to further improve the image processing effect, the present disclosure further provides another method for constructing a model, and for ease of understanding, a description is made with reference to the accompanying drawings as below. FIG. 4 illustrates another possible implementation of the method for constructing the model according to an embodiment of the present disclosure. In the implementation, the method for constructing the model may also include following S104 in addition to the above S101 to S103. S104 is performed after S103. FIG. 4 is a flowchart of another method for constructing a model provided in the present disclosure.

S104: Fine-tune the model to be used using a preset image dataset to obtain an image processing model, where the image processing model includes a target detection model, a semantic segmentation model, or a key point detection model.

The preset image dataset refers to an image dataset used when fine-tuning is performed on the image processing model in the above target application field, and each image data in the preset image dataset belongs to multi-object image data.

Additionally, the present disclosure does not limit the implementation of the above preset image dataset. For example, when the target application field is the target detection field, the preset image dataset refers to an image dataset (e.g., multi-object image dataset) used when fine-tuning is performed on the target detection model. For another example, when the target application field is the image segmentation field, the preset image dataset refers to an image dataset used when fine-tuning is performed on the image segmentation model. For another example, when the target application field is the key point detection field, the preset image dataset refers to an image dataset used when fine-tuning is performed on the key point detection model.

Additionally, the present disclosure does not limit the implementation of the above S104, which may be, for example, implemented using any existing or future method applicable to fine-tune the image processing model in the above target application field.

Further, the present disclosure does not limit the “image processing model” in the above S104. For example, when the above target application field is the target detection field, the image processing model is the target detection model. For another example, when the above target application field is the image segmentation field, the image processing model is the image segmentation model. For another example, when the above target application field is the key point detection field, the image processing model is the key point detection model.

On the basis of related content of S101 to S104 above, for the method for constructing the model provided in this embodiment of the present disclosure, the method for constructing the model may be applied to a plurality of image processing fields such as the target detection field, the image segmentation field, or the key point detection field. The method for constructing the model may specifically include: first using the two-stage-based model construction method (e.g., the two-stage pre-training process shown in FIG. 2 to FIG. 3) provided in the present disclosure to perform pre-training on all networks in the image processing model in the target detection field to obtain the pre-trained image processing model, thereby enabling all the networks in the pre-trained image processing model to have good data processing performance; and fine-tuning the pre-trained image processing model to obtain the fine-tuned image processing model, thereby enabling the fine-tuned image processing model to have good image processing performance in the target detection field, and better finish an image processing task in the target detection field (e.g., target detection task, image segmentation task, or key point detection task), so as to improve the image processing effect in the target detection field.

Additionally, for the method for constructing the model provided in the present disclosure, the multi-object image data is used during pre-training and the fine-tuning involved in the method for constructing the model, thereby keeping consistency in the image data aspect between the pre-training and the fine-tuning, so as to effectively avoid adverse effects caused when the pre-training and the fine-tuning are different in the image data aspect, and then allow the image processing model constructed based on the method for constructing the model to have good image processing performance.

Additionally, for the method for constructing the model provided in the present disclosure, both the pre-training and the fine-tuning involved in the method for constructing the model require training on all the networks in the image data model, thereby keeping consistency in the object training aspect between the pre-training and the fine-tuning, so as to effectively avoid adverse effects caused when the pre-training and the fine-tuning are different in the object training aspect, and then allow the image processing model constructed based on the method for constructing the model to have good image processing performance.

Further, for the method for constructing the model provided in the present disclosure, both the pre-training and the fine-tuning involved in the method for constructing the model focus on the classification task and the regression task at the same time, thereby keeping consistency in the learning task aspect between the pre-training and the fine-tuning, so as to effectively avoid adverse effects caused when the pre-training and the fine-tuning are different in the learning task aspect, and then allow the image processing model constructed based on the method for constructing the model to have good image processing performance.

Moreover, the present disclosure does not limit an executing entity of the above model construction method. For example, the method for constructing the model provided in this embodiment of the present disclosure may be applied to a terminal device, a server, or other devices with data processing functions. For another example, the method for constructing the model provided in this embodiment of the present disclosure may also be implemented through a data communication process between the terminal device and the server.

Based on the method for constructing the model provided in this embodiment of the present disclosure, an embodiment of the present disclosure further provides an apparatus for constructing a model, which is explained and described with reference to FIG. 5 below. FIG. 5 is a schematic diagram of a structure of an apparatus for constructing a model according to an embodiment of the present disclosure. It should be noted that for technical details of the apparatus for constructing the model provided in this embodiment of the present disclosure, reference is made to the related content of the above model construction method.

As shown in FIG. 5, the apparatus for constructing the model 500 provided in this embodiment of the present disclosure includes:
a first training unit 501, configured to train a model to be processed using a first dataset to obtain a first model, where the first dataset includes at least one first image data, and the first model includes a backbone network;
a model construction unit 502, configured to construct a second model according to the backbone network in the first model, where the second model includes the backbone network and a first processing network, and the first processing network refers to all or part of other networks other than the backbone network in the second model; and
a second training unit 503, configured to train the second model using a second dataset to obtain a model to be used, where the model to be used includes the backbone network and a second processing network, network parameters of the backbone network in the second model are kept unchanged during the training of the second model, the second processing network refers to the training result of the first processing network in the second model, and the second dataset includes at least one second image data.

In a possible implementation, the first processing network is used to process output data of the backbone network so as to obtain an output result of the second model.

In a possible implementation, the first image data belongs to single-object image data;
and/or,
the second image data comprises at least two objects.

In a possible implementation, the apparatus for constructing the model 500 further includes:
an initialization unit, configured to initialize an online model and a momentum model using the second model.

The second training unit 503 is specifically configured to: determine the model to be used according to the second dataset, the online model, and the momentum model.

In a possible implementation, the second training unit 503 includes:
an image selection subunit, configured to select image data to be processed from the at least one second image data;
a first obtaining subunit, configured to obtain at least two image data to be used and object area labels corresponding to the at least two image data to be used, where the image data to be used is determined according to the image data to be processed, and the object area labels corresponding to the image data to be used are determined according to object area labels corresponding to the image data to be processed;
a first determination subunit, configured to determine object area prediction results corresponding to the at least two image data to be used using the online model and the momentum model;
a first update subunit, configured to update the online model and the momentum model according to the object area prediction results corresponding to the at least two image data to be used and the object area labels corresponding to the at least two image data to be used, and return to the image selection subunit to continue performing selecting image data to be processed from the at least one second image data; and
a second determination subunit, configured to determine the model to be used according to the online model when a preset stopping condition is met.

In a possible implementation, the at least two image data to be used includes at least one third image data and at least one fourth image data;
an object area prediction result corresponding to the third image data is determined using the online model; and
an object area prediction result corresponding to the fourth image data is determined using the momentum model.

In a possible implementation, the first update subunit includes:
a third determination subunit, configured to determine a regression loss corresponding to the online model according to the object area prediction result corresponding to the at least one third image data and object area labels corresponding to the at least one third image data;
a fourth determination subunit, configured to determine a contrastive loss corresponding to the online model according to the object area prediction result corresponding to the at least one third image data and the object area prediction result corresponding to the at least one fourth image data;
a second update subunit, configured to update the online model according to the regression loss and the contrastive loss; and
a third update subunit, configured to update the momentum model according to the updated online model.

In a possible implementation, the second update subunit is specifically configured to: update network parameters of the first processing network in the online model according to the regression loss and the contrastive loss;
and/or,
the third update subunit is specifically configured to: update network parameters of a first processing network in the momentum model according to the network parameters of the first processing network in the updated online model.

In a possible implementation, the third update subunit is specifically configured to: perform weighted summation processing on the network parameters of the first processing network in the momentum model before update and the network parameters of the first processing network in the updated online model, to obtain network parameters of the first processing network in the updated momentum model.

In a possible implementation, the object area label includes at least one target area representation data, and the object area prediction result includes at least one predicted area feature.

The first update subunit further includes:
a fifth determination subunit, configured to determine, based on a correspondence between at least one target area representation data corresponding to the third image data and at least one target area representation data corresponding to the fourth image data, a positive sample and a negative sample of respective predicted area features corresponding to the at least one third image data from at least one predicted area feature corresponding to the at least one fourth image data.

The fourth determination subunit is specifically configured to: determine a contrastive loss corresponding to the online model according to at least one predicted area feature corresponding to the at least one third image data, and the positive sample and the negative sample of respective predicted area features corresponding to the at least one third image data.

In a possible implementation, the object area prediction result further includes predicted area representation data corresponding to respective predicted area features;
the at least one predicted area feature corresponding to the third image data includes an area feature to be used;
there is a correspondence between target area representation data corresponding to a positive sample of the area feature to be used and target area representation data corresponding to the area feature to be used, and there is no correspondence between target area representation data corresponding to a negative sample of the area feature to be used and the target area representation data corresponding to the area feature to be used;
the target area representation data corresponding to the positive sample is determined according to a size of an overlapping area between predicted area representation data corresponding to the positive sample and each target area representation data corresponding to the fourth image data to which the positive sample belongs;
the target area representation data corresponding to the area feature to be used is determined according to a size of an overlapping area between predicted area representation data corresponding to the area feature to be used and each target area representation data corresponding to the third image data to which the area feature to be used belongs; and
the target area representation data corresponding to the negative sample is determined according to a size of an overlapping area between predicted area representation data corresponding to the negative sample and each target area representation data corresponding to the fourth image data to which the negative sample belongs.

In a possible implementation, the process of obtaining object area labels corresponding to the image data to be processed includes: performing object area searching on the image data to be processed using a selective search algorithm, to obtain the object area labels corresponding to the image data to be processed;
or,
the process of obtaining object area labels corresponding to the image data to be processed includes: looking up the object area labels corresponding to the image data to be processed from a pre-constructed mapping relationship, where the mapping relationship includes a correspondence between respective second image data and the object area labels corresponding to respective second image data; and the object area labels corresponding to the second image data are determined by performing object area searching on the second image data using the selective search algorithm.

In a possible implementation, the output result of the second model is a target detection result, a semantic segmentation result, or a key point detection result.

In a possible implementation, the first training unit 501 is specifically configured to: perform fully-supervised training on the model to be processed using the first dataset to obtain the first model;
or,
perform self-supervised training on the model to be processed using the first dataset to obtain the first model.

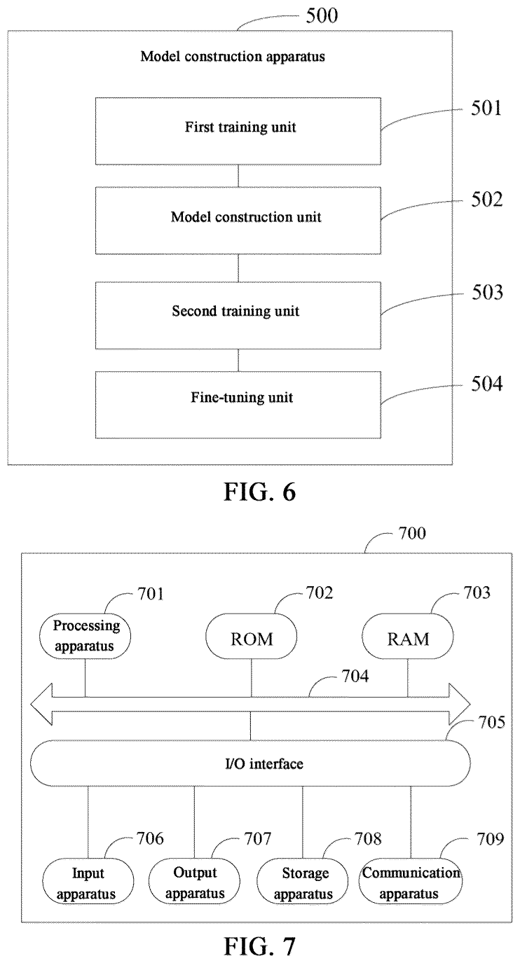

In a possible implementation, as shown in FIG. 6, the apparatus for constructing the model 500 further includes:
a fine-tuning unit 504, configured to fine-tune the model to be used using a preset image dataset to obtain an image processing model, where the image processing model includes a target detection model, a semantic segmentation model, or a key point detection model.

Based on the related content of the above model construction apparatus 500, for the apparatus for constructing the model 500, the first dataset (e.g., a large amount of single-object image data) is first used to train the model to be processed to obtain the first model, such that the backbone network in the first model has a good image feature extraction function, thereby achieving the pre-training of the backbone network in the machine learning model in a certain image processing field; then, the second model is constructed according to the backbone network in the first model, such that the image processing function achieved by the second model is kept consistent with the image processing function to be achieved by the machine learning model; and then, the second dataset (e.g., some multi-object image data) is used to train the second model, and the network parameters of the backbone network in the second model are constantly kept unchanged in the training process of the second model, such that when the trained second model is determined as the model to be used, the backbone network in the model to be used is kept consistent with the backbone network in the first model, and the second processing network in the model to be used refers to the training result of the first processing network in the second model, thus the other networks in the machine learning model can be pre-trained on the premise of fixing the backbone network, the well-constructed image processing model (e.g., the target detection model) with good image processing performance can be obtained by subsequent fine-tuning, and construction processing of the machine learning model in these image processing fields can be achieved accordingly.

Additionally, the method for constructing the model provided in the present disclosure not only pre-trains the backbone network in the above image processing model (e.g., the target detection model), but also pre-trains the other networks other than the backbone network in the image processing model (e.g., the detection head network), and therefore all networks in the final pre-trained model have good data processing performance, thereby effectively avoiding adverse effects caused by only performing pre-training on the backbone network, so as to effectively improve the image processing effect (e.g., the target detection effect) of the final constructed image processing model.

Additionally, the method for constructing the model provided in the present disclosure not only uses the single-object image data for model pre-training, but also uses the multi-object image data for the model pre-training, such that the final pre-trained model has a good image processing function for the multi-object image data, thereby effectively avoiding adverse effects caused by performing model pre-training only using the single-object image data, so as to effectively improve the image processing effect (e.g., the target detection effect) of the final constructed image processing model.

Further, the method for constructing the model provided in the present disclosure not only focuses on the classification task but also focuses on the regression task, such that the final pre-trained model has good image processing performance, thereby effectively avoiding adverse effects caused by only focusing on the classification task for pre-training, so as to effectively improve the image processing effect (e.g., the target detection effect) of the final constructed image processing model.

Moreover, the embodiments of the present disclosure further provide an electronic device. The device includes a processor and a memory. The memory is configured to store an instruction or a computer program. The processor is configured to execute the instruction or the computer program in the memory to cause the electronic device to perform any implementation of the method for constructing the model provided in this embodiment of the present disclosure.

Reference is made to FIG. 7, which is a schematic diagram of a structure of an electronic device 700 suitable for implementing an embodiment of the present disclosure. A terminal device in this embodiment of the present disclosure may include, but is not limited to, mobile terminals such as a mobile phone, a notebook computer, a digital broadcast receiver, a personal digital assistant (PDA), a portable Android device (PAD), a portable media player (PMP), and a vehicle terminal (e.g., vehicle navigation terminal), and fixed terminals such as a digital TV and a desktop computer. The electronic device shown in FIG. 7 is merely an example, and should not impose any limitation on the function and scope of use of the embodiments of the present disclosure.

As shown in FIG. 7, the electronic device 700 may include a processing apparatus (e.g., central processing unit and graphics processing unit) 701, which may perform various suitable actions and processing according to a program stored on a read-only memory (ROM) 702 or a program loaded from a storage apparatus 708 into a random-access memory (RAM) 703. The RAM 703 further stores various programs and data needed by the operation of the electronic device 700. The processing apparatus 701, the ROM 702, and the RAM 703 are connected to one another through a bus 704. An input/output (I/O) interface 705 is also connected to the bus 704.

Typically, the following apparatuses may be connected to the I/O interface 705: an input apparatus 706 including, for example, a touch screen, a touch pad, a keyboard, a mouse, a camera, a microphone, an accelerometer, and a gyroscope; an output apparatus 707 including, for example, a liquid crystal display (LCD), a speaker, and a vibrator; the storage apparatus 708 including, for example, a magnetic tape and a hard drive; and a communication apparatus 709. The communication apparatus 709 may allow the electronic device 700 to be in wireless or wired communication with other devices for data exchange. Although FIG. 7 illustrates the electronic device 700 with various apparatuses, it should be understood that it is not necessary to implement or have all the shown apparatuses. It may be an alternative to implement or have more or fewer apparatuses.

In particular, the above process described with reference to the flowcharts according to the embodiments of the present disclosure may be implemented as a computer software program. For example, an embodiment of the present disclosure includes a computer program product, which includes a computer program carried on a non-transitory computer-readable medium, where the computer program includes program code used to perform the method shown in the flowchart. In this embodiment, the computer program may be downloaded and installed from the network through the communication apparatus 709, or installed from the storage apparatus 708, or installed from the ROM 702. The computer program, when executed by the processing apparatus 701, performs the above functions limited in the method in this embodiment of the present disclosure.

The electronic device provided in this embodiment of the present disclosure and the method provided in the above embodiment belong to the same inventive concept, and for technical details not described in detail in this embodiment, reference may be made to the above embodiment. This embodiment and the above embodiment have the same beneficial effects.

An embodiment of the present disclosure further provides a computer-readable medium, having an instruction or a computer program stored therein. The instruction or the computer program, when run on a device, causes the device to perform any implementation of the method for constructing the model provided in this embodiment of the present disclosure.

It should be noted that the above computer-readable medium in the present disclosure may be either a computer-readable signal medium or a computer-readable storage medium, or any combination of the two. The computer-readable storage medium may be, for example, but is not limited to, electric, magnetic, optical, electromagnetic, infrared, or semiconductor systems, apparatuses, or devices, or any combination of the above. More specific examples of the computer-readable storage medium may include, but are not limited to: an electrical connection with one or more wires, a portable computer disk, a hard drive, a random access memory (RAM), a read-only memory (ROM), an erasable programmable read-only memory (EPROM or a flash memory), an optical fiber, a portable compact disk read-only memory (CD-ROM), an optical storage device, a magnetic storage device, or any suitable combination of the above. In the present disclosure, the computer-readable storage medium may be any tangible medium including or storing a program, and the program may be for use by or for use in combination with an instruction execution system, apparatus, or device. However, in the present disclosure, the computer-readable signal medium may include a data signal propagated in a baseband or as a part of a carrier, where the data signal carries computer-readable program code. The propagated data signal may take various forms, including but not limited to an electromagnetic signal, an optical signal, or any suitable combination of the above. The computer-readable signal medium may also be any computer-readable medium other than the computer-readable storage medium. The computer-readable signal medium may send, propagate, or transmit a program for use by or for use in combination with the instruction execution system, apparatus, or device. The program code included in the computer-readable medium may be transmitted by any suitable medium, including but not limited to a wire, an optical cable, radio frequency (RF), etc., or any suitable combination of the above.

In some implementations, a client and a server may communicate using any currently known or future-developed network protocols such as a hypertext transfer protocol (HTTP), and may also be interconnected with digital data communication in any form or medium (e.g., communication network). Examples of the communication network include a local area network (“LAN”), a wide area network (“WAN”), an internetwork (e.g., the Internet), a peer-to-peer network (e.g., ad hoc peer-to-peer network), and any currently known or future-developed network.

The above computer-readable medium may be included in the above electronic device; or it may also be separate and not assembled in the electronic device.

The above computer-readable medium carries one or more programs. The above one or more programs, when executed by the electronic device, cause the electronic device to perform the above method.

Computer program code for performing operations of the present disclosure may be written in one or more programming languages or a combination thereof, where the above programming languages include, but are not limited to, object-oriented programming languages, such as Java, Smalltalk, and C++, and further include conventional procedural programming languages, such as “C” language or similar programming languages. The program code may be executed entirely on a user computer, partly on the user computer, as a stand-alone software package, partly on the user computer and partly on a remote computer, or entirely on the remote computer or the server. In the case of involving the remote computer, the remote computer may be connected to the user computer through any type of network, including a local area network (LAN) or a wide area network (WAN), or may be connected to an external computer (e.g., utilizing an Internet service provider for Internet connectivity).

The flowcharts and the block diagrams in the accompanying drawings illustrate the possibly implemented system architecture, functions, and operations of the system, the method, and the computer program product according to the various embodiments of the present disclosure. In this regard, each block in the flowcharts or the block diagrams may represent a module, a program segment, or a part of code, and the module, the program segment, or the part of code contains one or more executable instructions for implementing specified logical functions. It should also be noted that in some alternative implementations, the functions marked in the blocks may also occur in an order different from that marked in the accompanying drawings. For example, two blocks shown in succession may actually be performed substantially in parallel, or may sometimes be performed in a reverse order, depending on the functions involved. It should also be noted that each block in the block diagrams and/or the flowcharts, and a combination of the blocks in the block diagrams and/or the flowcharts may be implemented using a dedicated hardware-based system that performs specified functions or operations, or may be implemented using a combination of dedicated hardware and computer instructions.

The involved units described in the embodiments of the present disclosure may be implemented through software or hardware. The name of the unit/module does not limit the unit in certain cases.

Herein, the functions described above may be at least partially executed by one or more hardware logic components. For example, without limitation, exemplary hardware logic components that can be used include: a field-programmable gate array (FPGA), an application specific integrated circuit (ASIC), an application specific standard part (ASSP), a system on chip (SOC), a complex programmable logic device (CPLD), etc.

In the context of the present disclosure, a machine-readable medium may be a tangible medium that may include or store a program for use by or for use in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above content. More specific examples of the machine-readable storage medium may include an electrical connection based on one or more wires, a portable computer disk, a hard drive, a random-access memory (RAM), a read-only memory (ROM), an erasable programmable read-only memory (EPROM or a flash memory), an optical fiber, a portable compact disk read-only memory (CD-ROM), an optical storage device, a magnetic storage device, or any suitable combination of the above content.

It should be noted that the various embodiments in the specification are described in a progressive manner, highlighting the differences between each embodiment and the other embodiments. The similar or identical parts between different embodiments may be cross-referenced to each other. The system or the apparatus disclosed in the embodiments corresponds to the method disclosed in the embodiment, and therefore the description is simple, and for associated parts, reference is made to part of the description of the method.

It should be understood that in the present disclosure, “at least one (item)” means one or more, and “a plurality of” means two or more. The term “and/or” is an association relationship for describing associated objects, indicating that there may be three relationships. For example, “A and/or B” may represent three situations: only A, only B, and both A and B, where A and B may be in a singular or plural form. The character “/” generally indicates an “or” relationship between preceding and succeeding associated objects. “At least one of the following items” or similar expressions thereof refer to any combination of these items, including any combination of single or plural items. For example, at least one of a, b, or c may represent: a, b, c, “a and b”, “a and c”, “b and c”, or “a, b, and c”, where a, b, and c may be single or plural.

It should be further noted that herein, relational terms such as first and second are used only to distinguish one entity or operation from another and do not necessarily require or imply any actual relationship or order between these entities or operations. In addition, the terms “comprise” and “comprising”, “include” and “including” or any other variations thereof are intended to cover non-exclusive inclusions, and therefore a process, a method, an article, or a device including a series of elements not only includes those elements but also includes other elements not clearly listed, or further includes elements inherent to the process, the method, the article, or the device. In the absence of further restrictions, an element specified by the phrase “including a . . . ” does not exclude the existence of other identical elements in the process, the method, the article, or the device that includes the element.

The steps of the method or the algorithm described in combination with the embodiments disclosed herein may be implemented directly by hardware, a software module executed by the processor, or a combination of both. The software module may be arranged in the random-access memory (RAM), an internal memory, the read-only memory (ROM), the erasable programmable ROM, an electrically erasable programmable ROM, a register, the hard drive, a removable disk, the CD-ROM, or any other form of storage medium known in the technical field.

Those skilled in the art can implement or use the present disclosure according to the above descriptions of the disclosed embodiments. More modifications for these embodiments are apparent to those skilled in the art, and general principles defined herein may be implemented in other embodiments without departing from the spirit or scope of the present disclosure. Therefore, the present disclosure will not be limited by these embodiments shown herein but is required to conform to a widest scope consistent with the principles and novel characteristics disclosed herein.

1. A method for constructing a model, comprising:
training, using a first dataset, a model to be processed to obtain a first model, the first dataset comprising at least one first image data, and the first model comprising a backbone network;
constructing, according to the backbone network in the first model, a second model, the second model comprising the backbone network and a first processing network, and the first processing network referring to all or part of other networks other than the backbone network in the second model; and
training, using a second dataset, the second model to obtain a model to be used, the model to be used comprising the backbone network and a second processing network, network parameters of the backbone network in the second model kept unchanged during training of the second model, the second processing network referring to a training result of the first processing network in the second model, and the second dataset comprising at least one second image data.

2. The method of claim 1, wherein the first processing network is used to process output data of the backbone network so as to obtain an output result of the second model.

3. The method of claim 1, wherein the first image data belongs to single-object image data,
and/or,
the second image data comprises at least two objects.

4. The method of claim 1, further comprising:
initializing, using the second model, an online model and a momentum model; and
training, using the second dataset, the second model to obtain the model to be used, comprising:
determining the model to be used according to the second dataset, the online model, and the momentum model.

5. The method of claim 4, wherein determining the model to be used comprises:
selecting image data to be processed from the at least one second image data;
obtaining at least two image data to be used and object area labels corresponding to the at least two image data to be used, the image data to be used being determined according to the image data to be processed, and the object area labels corresponding to the image data to be used being determined according to object area labels corresponding to the image data to be processed;
determining, using the online model and the momentum model, object area prediction results corresponding to the at least two image data to be used; and
updating the online model and the momentum model according to the object area prediction results corresponding to the at least two image data to be used and the object area labels corresponding to the at least two image data to be used, continuing performing selecting image data to be processed from the at least one second image data, and determining the model to be used according to the online model in response to a preset stopping condition being met.

6. The method of claim 5, wherein the at least two image data to be used comprises at least one third image data and at least one fourth image data,
an object area prediction result corresponding to the third image data is determined using the online model, and
an object area prediction result corresponding to the fourth image data is determined using the momentum model.

7. The method of claim 6, wherein updating the online model and the momentum model according to the object area prediction results corresponding to the at least two image data to be used and the object area labels corresponding to the at least two image data to be used comprises:
determining a regression loss corresponding to the online model according to an object area prediction result corresponding to the at least one third image data and object area labels corresponding to the at least one third image data;
determining a contrastive loss corresponding to the online model according to the object area prediction result corresponding to the at least one third image data and an object area prediction result corresponding to the at least one fourth image data;
updating the online model according to the regression loss and the contrastive loss; and
updating the momentum model according to the updated online model.

8. The method of claim 5, wherein updating the online model and the momentum model according to the object area prediction results corresponding to the at least two image data to be used and the object area labels corresponding to the at least two image data to be used comprises:
determining a model loss of the online model according to the object area prediction results corresponding to the at least two image data to be used and the object area labels corresponding to the at least two image data to be used;
updating, according to the model loss, network parameters of a first processing network in the online model; and
updating network parameters of a first processing network in the momentum model according to the network parameters of the first processing network in the updated online model.

9. The method of claim 8, wherein updating network parameters of the first processing network in the momentum model according to the network parameters of the first processing network in the updated online model comprises:
performing weighted summation processing on the network parameters of the first processing network in the momentum model before updating and the network parameters of the first processing network in the updated online model, to obtain network parameters of the first processing network in the updated momentum model.

10. The method of claim 7, wherein the object area labels comprise at least one target area representation data, the object area prediction result comprises at least one predicted area feature,
and the method further comprises:
determining, based on a correspondence between at least one target area representation data corresponding to the third image data and at least one target area representation data corresponding to the fourth image data, a positive sample and a negative sample of respective predicted area features corresponding to the at least one third image data from at least one predicted area feature corresponding to the at least one fourth image data; and
wherein determining the contrastive loss corresponding to the online model according to the object area prediction result corresponding to the at least one third image data and the object area prediction result corresponding to the at least one fourth image data, comprises:
determining the contrastive loss corresponding to the online model according to at least one predicted area feature corresponding to the at least one third image data, and the positive sample and the negative sample of respective predicted area features corresponding to the at least one third image data.

11. The method of claim 10, wherein the at least one predicted area feature corresponding to the third image data comprises an area feature to be used,
target area representation data corresponding to a positive sample of the area feature to be used has a correspondence with target area representation data corresponding to the area feature to be used, and
target area representation data corresponding to a negative sample of the area feature to be used has no correspondence with target area representation data corresponding to the area feature to be used.

12. The method of claim 5, wherein obtaining object area labels corresponding to the image data to be processed comprises:
performing, using a selective search algorithm, object area searching on the image data to be processed to obtain the object area labels corresponding to the image data to be processed;
or,
obtaining object area labels corresponding to the image data to be processed comprises:
looking up the object area labels corresponding to the image data to be processed from a pre-constructed mapping relationship, the mapping relationship comprising a correspondence between respective second image data and object area labels corresponding to respective second image data; and the object area labels corresponding to the second image data are determined by performing object area searching on the second image data using the selective search algorithm.

13. The method of claim 2, wherein the output result of the second model is a target detection result, a semantic segmentation result, or a key point detection result.

14. The method of claim 1, wherein training, using the first dataset, the model to be processed to obtain a first model, comprises:
performing, using the first dataset, fully-supervised training on the model to be processed to obtain the first model;
or,
performing, using the first dataset, self-supervised training on the model to be processed to obtain the first model.

15. The method of claim 1, further comprising:
fine-tuning the model to be used using a preset image dataset to obtain an image processing model, the image processing model comprising a target detection model, a semantic segmentation model, or a key point detection model.

16. (canceled)

17. An electronic device, comprising a processor and a memory, wherein
the memory is configured to store an instruction or a computer program; and
the processor is configured to execute the instruction or the computer program in the memory to cause the electronic device to:
train, using a first dataset, a model to be processed to obtain a first model, the first dataset comprising at least one first image data, and the first model comprising a backbone network:
construct, according to the backbone network in the first model, a second model, the second model comprising the backbone network and a first processing network, and the first processing network referring to all or part of other networks other than the backbone network in the second model; and
train, using a second dataset, the second model to obtain a model to be used, the model to be used comprising the backbone network and a second processing network, network parameters of the backbone network in the second model kept unchanged during training of the second model, the second processing network referring to a training result of the first processing network in the second model, and the second dataset comprising at least one second image data.

18. A non-transitory computer-readable medium, having an instruction or a computer program stored therein, wherein the instruction or the computer program, when run on a device, causes the device:
train, using a first dataset, a model to be processed to obtain a first model, the first dataset comprising at least one first image data, and the first model comprising a backbone network:
construct, according to the backbone network in the first model, a second model, the second model comprising the backbone network and a first processing network, and the first processing network referring to all or part of other networks other than the backbone network in the second model; and
train, using a second dataset, the second model to obtain a model to be used, the model to be used comprising the backbone network and a second processing network, network parameters of the backbone network in the second model kept unchanged during training of the second model, the second processing network referring to a training result of the first processing network in the second model, and the second dataset comprising at least one second image data.

19. The electronic device of claim 17, the processor is further configured to execute the instruction or the computer program in the memory to cause the electronic device to:
initialize, using the second model, an online model and a momentum model; and
train, using the second dataset, the second model to obtain the model to be used, comprising:
determine the model to be used according to the second dataset, the online model, and the momentum model.

20. The electronic device of claim 19, wherein the instruction or the computer program in the memory to cause the electronic device to determine the model to be used comprises the instruction or the computer program in the memory to cause the electronic device to:
select image data to be processed from the at least one second image data;
obtain at least two image data to be used and object area labels corresponding to the at least two image data to be used, the image data to be used being determined according to the image data to be processed, and the object area labels corresponding to the image data to be used being determined according to object area labels corresponding to the image data to be processed;
determine, using the online model and the momentum model, object area prediction results corresponding to the at least two image data to be used; and
update the online model and the momentum model according to the object area prediction results corresponding to the at least two image data to be used and the object area labels corresponding to the at least two image data to be used, continuing performing selecting image data to be processed from the at least one second image data, and determining the model to be used according to the online model in response to a preset stopping condition being met.

21. The electronic device of claim 20, wherein the at least two image data to be used comprises at least one third image data and at least one fourth image data,
an object area prediction result corresponding to the third image data is determined using the online model, and
an object area prediction result corresponding to the fourth image data is determined using the momentum model.
